(19) United States
(12) Patent Application Publication
(10) Pub. No.: US 2016/0253743 A1
(43) Pub. Date: Sep. 1, 2016

(54) INTERACTIVE IMAGE CAPTURE, MARKETING AND DISTRIBUTION

(71) Applicant: Clifford R. David, New York, NY (US)

(72) Inventor: Clifford R. David, New York, NY (US)

(73) Assignee: FREEZE FRAME, LLC, Orlando, FL (US)

(21) Appl. No.: 15/000,555

(22) Filed: Jan. 19, 2016

Related U.S. Application Data
(63) Continuation-in-part of application No. 14/135,858, filed on Dec. 20, 2013, now Pat. No. 9,270,841.
Application No. 14/135,858 is a continuation-in-part of application No. 13/914,533, filed on Jun. 10, 2013.
Application No. 13/914,533 is a continuation-in-part of application No. 12/772,275, filed on May 3, 2010, now Pat. No. 8,463,654.
Application No. 13/914,533 is a continuation-in-part of application No. 13/116,487, filed on May 26, 2011, now Pat. No. 8,615,443.
Application No. 13/116,487 is a continuation of application No. 11/691,583, filed on Mar. 27, 2007, now Pat. No. 7,966,223.
Application No. 11/691,583 is a continuation-in-part of application No. 11/279,642, filed on Apr. 13, 2006, now Pat. No. 7,881,968.
Application No. 13/914,533 is a continuation-in-part of application No. 13/299,679, filed on Nov. 18, 2011, now abandoned.
Application No. 13/299,679 is a continuation-in-part of application No. 11/854,605, filed on Sep. 13, 2007, now Pat. No. 8,260,674.
Application No. 11/854,605 is a continuation-in-part of application No. 11/691,583, filed on Mar. 27, 2007, now Pat. No. 7,966,223.
Application No. 11/691,583 is a continuation-in-part of application No. 11/279,642, filed on Apr. 13, 2006, now Pat. No. 7,881,968.
Application No. 13/914,533 is a continuation-in-part of application No. 13/594,299, filed on Aug. 24, 2012, now Pat. No. 9,270,840.
(60) Provisional application No. 61/174,515, filed on May 1, 2009.
(60) Provisional application No. 61/293,035, filed on Jan. 7, 2010.
(60) Provisional application No. 60/671,928, filed on Apr. 15, 2005.
(60) Provisional application No. 61/415,026, filed on Nov. 18, 2010.
(60) Provisional application No. 60/671,928, filed on Apr. 15, 2005.
(60) Provisional application No. 61/526,823, filed on Aug. 24, 2011.

(51) Int. Cl. G06Q 30/06; H04N 5/247; H04N 5/44; G11B 27/031; H04N 21/4788; H04N 21/647; H04N 21/2543; G11B 27/10; H04N 21/845; H04N 21/431; H04N 7/015; H04N 21/81

(52) U.S. Cl. CPC G06Q 30/0643; G06Q 30/0639; H04N 7/015; H04N 5/247; H04N 5/44; G11B 27/031; H04N 21/812; H04N 21/647; H04N 21/2543; G11B 27/10; H04N 21/8456; H04N 21/4312; H04N 21/4788

(57) ABSTRACT

Automated systems and methods for capturing digital images of a customer with multiple high-definition video cameras mounted in a venue such as a stadium, interactively communicating with venue customers to receive customer requests for images and information regarding customer locations in the venue and in response identify camera images containing the requested images and pixel groups therein containing images requested by customers, processing the requests to generate preview and send to customers for approval and ordering, and generating and sending final images in response to purchase requests and calculating and automatically applying charges to customers and third parties for promotional material sent to customers and making payments to third parties having rights in image content sent to customers. Variations of embodiments are suitable for venues such as a museum, a garden, a zoo, a religious institution, a theme park, or any other venue where imaging is possible and practical, or in a defined time period, such as a trip or vacation. The systems and methods can be essentially fully automated, using automated cameras and essentially only electronic communications between a customer and a computerized central facility, or can include a human representative or contractor for some of the operations. The souvenir can include other customer-related elements, such as “stock” images, composited images that include the customer or customer-related people or objects, and text and sound.

### REFERENCE TO RELATED APPLICATIONS

This patent application is a continuation-in-part (CIP) of application Ser. No. 13/914,533 filed Jun. 10, 2013, which is a CIP of:
(1) application Ser. No. 12/772,275 filed May 3, 2010 and now U.S. Pat. No. 8,463,654 issued Jun. 11,2013, which claims the benefit of provisional applications 61/174,515 filed May 1, 2009 and 61/293,035 filed Jan. 7, 2010;
(2) application Ser. No. 13/116,487 filed May 26, 2011, which is allowed, which is a continuation of Ser. No. 11/691,583 filed Mar. 27, 2007 and now U.S. Pat. No. 7,966,223 issued Jun. 21, 2011, which is a CIP of Ser. No. 11/279,642 filed Apr. 13, 2006 and now U.S. Pat. No. 7,881,968 issued Feb. 1, 2011, which claims the benefit of provisional application 60/671,928 filed Apr. 15, 2005;
(3) application Ser. No. 13/299,679 filed Nov. 18, 2011, which claims the benefit of provisional application No. 61/415,026 filed Nov. 18, 2010, which is a CIP of Ser. No. 11/854,605 filed Sep. 13, 2007 and now U.S. Pat. No. 8,260,674 issued Sep. 4, 2012, which itself is a continuation-in-part of Ser. No. 11/691,583 filed Mar. 27, 2007 and now U.S. Pat. No. 7,966,223 issued Jun. 21, 2011, which itself is a continuation-in-part of application Ser. No. 11/279,642 filed Apr. 13, 2006 and now U.S. Pat. No. 7,881,968 issued Feb. 1, 2011, which claims the benefit of provisional application 60/671,928 filed Apr. 15, 2005; and
(4) application Ser. No. 13/594,299 filed Aug. 24, 2012 and claiming the benefit of provisional application 61/526,823 filed Aug. 24, 2011.

This application incorporates by reference the entire contents of the utility and provisional applications identified above.

### FIELD

This patent specification relates to systems and methods configured to provide customers with quality images such as stills and video clips that can be taken in an automated process involving electronic communications with a computer system, or with the help of human intermediaries in some embodiments, and leads to creating and distributing to the customers or their designees material such as professional quality images, portfolios, and souvenir albums that may include other content such as text, audio, composited images, and other customized visual and audio material that involves the customers or memorializes a customer experience.

### BACKGROUND

Personal devices such as digital still and video cameras that are stand-alone or built into smartphones are widely available and used, but may not be able to provide images from viewpoints that the customer cannot access or when the customer desires a professional quality image of a special event taken at a time or from a location that is not conducive to using a personal devices. One example is a stadium during a game, where the customer may find it attractive to have an image or a portfolio that includes the customer and perhaps friends and is taken in a way that is not possible or practical to take with a personal camera. In addition, it may not be possible or practical for a customer to attractively format images taken with personal devices and to create electronic or printed portfolios, or to include sound or other images that are not easily accessible to the customer or to create composited images.

The sale of photographs taken by a photographer of a customer in, for example, a theme park, cruise, hotel, resort, or other event where there are large volumes of people present is known in the art. This approach has inherent inefficiencies, in that the photographer typically prints many more photographs than are ultimately sold, and the sale is dependent upon the customer's viewing and agreeing to purchase the photograph displayed after the event, thereby losing momentum caused by the excitement of the moment.

An additional issue with known systems is that images from certain vantage points, and including objects at a site being visited by the customer, which may comprise, for example, still or video images, are typically not possible or practical when taken by a photographer at a defined location within the site. Thus achieving viable perspectives to capture an image at a site from an optimal vantage point may be impossible for the customer.

Another issue with the known approach is that some sites do not permit photography at all, or may not permit flash photography, owing to security and/or other concerns. Such prohibitions can prevent the customer from capturing desired images that can comprise priceless memories.

Further, a customer may desire a photograph to be taken at a time when a photographer is not in the vicinity.

Another particular difficulty with photography in general is that there is no universally practical availability of good quality photograph then the photographer him/herself can be in the picture, nor of that person with a group. Personal camera equipment is typically not sufficiently sophisticated to produce a good product, and extra equipment, such as tripods and other accessories must be hauled along to accomplish self-photos. In the realm of videography, there is no practical way to film oneself when the camera is moving. Further, the technical skill is typically lacking, and professional quality photographs or videos taken by amateurs are rare.

Therefore, it would be desirable to provide systems and methods for more efficiently capturing and delivering photographic and/or video images and possibly related audio to a customer. It would also be desirable to provide systems and methods wherein the customer him/herself can be a subject of the image, especially in locations where amateur images are unavailable or impractical. It would be additionally desirable to provide systems and methods for efficiently culling a collection of many images to select a desirable subset and for distributing a collection of images captured at a site.

### SUMMARY OF THE DISCLOSURE

This patent specification describes an embodiment in which a system and a method are configured to:
a. Automatically take, over a selected time span and preferably with multiple cameras at multiple angles, high-definition, wide angle video or still images of large groups of people at sites where a high number of actual and potential customers assemble or pass through, such as sports stadiums or arenas, concerts, shows, political or other rallies, campaign venues, parks, tourist attractions such as Times Square, sports venues such as Marathon or ski races or ski resorts, and other possible sites. A single camera can be used in cases of sufficient field-of-view camera for a particular venue or event;
b. Provide facilities for zooming in or zooming out of individual customers or small groups to provide effects of zooming between images of small and large areas, similar in some ways to those in Google Earth;
c. Communicate with customers electronically through devices the customers carry such as smartphones or other electronic devices, or identify customers or smaller groups of customers through techniques such as automated location identification or facial recognition;
d. Automatically associate individual customers or smaller groups of customers with portions of the images of the large groups of customers through such communicating or identification;
e. Create customized images of individual customers or smaller groups of customers, at the request or consent thereof, by processing the automatically taken video or still images such as by cropping and zooming, and possibly by compositing or otherwise combining with other images;
f. Offer live preview of the customized images to customers through devices they carry or in other ways, and previews of portions of previously taken images;
g. Arrange for payment by customers for customized images, for any payment to third parties such as advertisers or holders of rights in images used in compositing with customers' images or for including in orders by customers, using information provided by customers or derived through technology such as facial or numerical recognition to identify customers for payment purposes and possibly for directed promotional material; and
h. Deliver the customized images to customers electronically or as prints or portfolios, possibly with added material such as souvenirs of events, educational material, or other add-ons.
   The term customer is used herein to refer to a single individual or sometimes to a group of individuals such as a family or another grouping.

In one example of this embodiment, e.g., for use in a football or baseball stadium, multiple cameras are mounted preferably at fixed positions and preferably in a way to take images of each section of the stadium from multiple angles, e.g., from the front, sides, and back, as well as of the sports event going on. Preferably, the cameras are very high definition, wide angle video cameras. One example is a Panasonic camera system that has a 64:9 aspect ratio. Preferably, at least some of the cameras are able to zoom in or out under computer control, and some may have computer-controlled tilt/pan capabilities. In a video mode, the cameras can be ON over a specified time span, for example from the time the stadium opens to the public for a sports event to the time it closes, or for specified intervals during this time span, or for a shorter or longer time span. The video from each camera is stored, preferably as high definition video frames, in a computer system for use as explained below. There is no need for a one-to-one correspondence between a camera and a customer when an image of the customer is taken, which eliminates or greatly reduces many issues with other arrangements such a need for accurate camera pointing and problems with camera vibration, drift, a need to trigger a cameras for specific shot, etc. Even if overlap and redundant coverage of the same area by cameras are instituted, the number of cameras and the attendant expenses are greatly reduced compared with the one customer/one camera per shot model. Of course, when a camera is zooming for a customer or a small group, that camera becomes dedicated for that particular shot.

Customers can interact with a computer system that controls the cameras and processes images in a variety of ways designed to allow customers to select and order portions of the images that the cameras have taken or will take. This communication can be through customer devices such as smartphones. For example, a customer can log on the computer system with unique customer identification information such as the customers mobile phone number and unique location information such as the customer's seat number. As another example, barcodes such as 1D or 2D barcodes can be provided on seats, and the customer can take a picture of the relevant barcode and email it or otherwise transmit it to the computer system to thereby identify the customer location. As yet other examples, a ticket can be issued to a customer, with alpha-numeric or barcode information thereon that the customer can scan with a smartphone and transmit to the computer system, or the customer location can be determined with GPS or other locating technology. This information allows the computer system to associate a customer with portions of the images that include the customer. Season ticket holders can have assigned seats, so their locations can be known to the computer system. The same can be the case with boxes such as corporate boxes at a stadium, where the location of boxes and their association with customers are known. In addition or instead, dedicated cameras can be positioned at or in association with respective boxes to take images of customers at the boxes, for unique perspective, possibly with the images prepaid by or for the box owner and possibly emblazoned with corporate logos or other promotional or souvenir material. Dedicated printers can be installed at the boxes with automated charging mechanisms. Because the cameras are at fixed positions, a specific location in a camera's field of view can be reliably associated with a portion of the image taken with that camera. To assist in initial calibration or with re-calibration, fiducials can be used, such as numbered columns in the stadium or special markers fixed at certain positions in a camera's field of view, so that a location of a customer can be determined in relation to such fiducials and the portion of the image that corresponds to the customer's location can be similarly determined in relation to where the fiducials appear in the image. The system can be set to require payment only for images that a customer has approved or selected, or to also require some advance fee for a customer to sign on to the system for a particular event or venue, which advance fee may be kept, or taken into account when ordering images, or even refunded in whole or in part.

In addition to customer identification and location information, the customers can communicate with the computer system regarding images in which the customer is or may be interested. For example, the customer can send through the customer device a request for an image (still or a video clip) of the customer or a small group around the customer that will be taken in several seconds, to allow the customer alone or the group to pose for the image. Or, the customer can send a request for an image taken at the time of a significant moment or time span of the sports event, or can specify any other past or future time for a desired image during the time span the cameras are ON. If a specific camera is not ON at a time specified by a customer but has a field of view that includes the customer's location, the computer system can turn it ON. In addition or instead, the customer can request other images, such as images of events in the game, images of the stadium or other sites, or composited images that include the customer or a small group and other materials such as images of players, player uniforms, team logos or symbols, etc. In addition, the customer request can include a request for audio from the customer's device or from another source to be included in the image that the customer is requesting, and a request for images that involve zooming in and/or out.

To allow a customer to select images, the system can send to the customer's device a preview clip of a time span or game event that the customer has specified, so the customer can select images from that video clip or the entire clip.

In response to a request from a customer that specifies the time of an image in which the customer is interested, the computer system processes three items of information: (1) the time (or time span or event) the customer has requested, (2) the customer's location (or the location of a small group that the request has specified), and (3) the images from cameras that include the portion of the stadium where the customer is located. To prevent or reduce discontinuities in case the request is for an image of a small group of customers, such as a group of friends at a game, the fields of view of the cameras overlap to a sufficient degree to allow such a small group to be within a field of view of at least one camera. In this processing, the computer system identifies one or more cameras that have taken or will take images of the customer location, identifies the images that were taken with those cameras at the specified time or time span (including after a time delay if the request was for images to be taken at a future time), and then identifies the portions of those images that correspond to the customer's or the small group's location. The computer system then crops and zooms through image processing to the identified portions so they preferably show only the customer or the small group. The spatial resolution of the cameras and the camera placement are designed to provide a professional quality customer image in this process. In case a customer requests images that involve zooming in and/or out that is better accomplished at least in part by optical rather than electronic means, at least some of the cameras can be provided with optical zooming and pointing facilities operating under computer control.

The computer system offers the customer previews of the requested images, which preview can be essentially real time or delayed by a specified interval. The preview can be sent electronically to the customer's device and viewed on the screen of that device. Provisions can be made to encourage the customer to order and pay for the image. For example, the transmitted preview image can be encoded to remain on the customer's screen only a short time, such as a few seconds, after which it can disappear or can be reduced to a lower resolution image or to a thumbprint, of the image can be otherwise encumbered with code or embedded notation that would make it unattractive for use as a final product. The preview image can be accompanied by ordering information including delivery options, choice of other or composited images, pricing, ads, etc.

Because preferably the cameras are ON continuously, a customer can select images from a past time, such as an image associated with an exciting moment in the game that occurred some time ago. A customer may be interested, for example, in an image of the customer's reaction to a home run or a touchdown. The camera system output can be video that is continuously recorded, or stills taken from time to time, so that a customer can select a moment or a time span even from the past, as well as from the present or future. If there is a concern with image storage requirements, the camera output can be stored in a more selective way, such as only when a customer has requested an image, or intermittently, or at significant events in the game or venue.

The customer then can send an order from the customer device to the computer system for some or all of the preview images. Or, the customer can edit the preview images on the customer device or in another way, for example by deleting frames from a preview video clip, deleting preview stills, selecting a frame from a preview video clip for use as a still, selecting different audio for association with an image, cropping an image, selecting different images for compositing with a customer image, selecting different other images, requesting material to be added to the images such as educational material, commentary on a game or player, etc. The customer then can send an order to the computer system via the customer device, specifying the ordered images and preferably packaging and delivery options, such as delivery via email or other electronic link, sending the ordered images to additional or alternative addresses, sending to social network links, sending to kiosks of printing establishments on the premises or at any other convenient location, delivery of prints to specified locations, creating an electronic or hard-copy portfolio, a selection of binding and size, etc. The system can be arranged to combine a customer's souvenir portfolio from a current game or venue with portfolios from past events, for example to provide the customer with a historical perspective of visits, or special moments of previous visits or venues, or some other mementos of the past.

In response to a customer order, the computer system selects the ordered images corresponding to the preview images that the customer has selected for ordering, and assembles them as ordered, including adding stock or other images and compositing images that the customer has requested, and delivers the resulting portfolio in the manner the customer has specified. In addition, the system charges the customer accordingly, as authorized by the customer. For example, the charge can be to a credit card number that the customer has provided, or to a charge account that the computer system has created for the customer, or to another charging system such as PayPal or another third party entity the charging of which the customer has authorized in a communication with the computer system.

Advertising material may be added in communications from the computer system to the customer device. In that case, the computer system can charge advertisers accordingly, preferably through an automated system of the type known in the pertinent technology that automatically charges advertiser for material delivered to potential customers or other destinations. The promotional material can be in the form of overlays on images, or interspersed with images, or sent to customers as a part of other interactions with customer devices such as smartphones, or offered to customers in other ways such as at kiosks or as hard copy material. To facilitate crowd flow, there can be many kiosks so that there need not be significant wait at any of them and so that traffic flow works well.

Material in which third parties hold rights may also be added to or composited into the images that a customer has requested. Such material can include images of players, team logos, game events, etc. If so, the computer system can be configured to make appropriate payment to the rights holders, and take this into account when calculating a charge to the customer.

The computer system can be configured to provide a degree of privacy to other people in the stadium. For example, if a customer requests a wide angle view of the stadium or a stadium section, the system can blur the faces of people other than the customer or a small group of the customer's friends, family, or associates before delivering a preview or final image to the customer or the customer's designees.

For promotional purposes, the system can show on large screens that are available in many stadiums, images of a customer or a small group, preferably connected in some way to the sports event, such as a composited image of a customer and a player or a team or a still or clip from the current or past games, together with invitations to customers to contact the computer system for images. In fact, any customer-selected image can be shown on large screen. The system can charge customers for displaying a customer images on large screens, can send customers information such as time codes advising when the pertinent images will show and on what large screen(s), and then reminding customers just before the large images appear. Contests can be held for the best or most popular customer images or customer-selected images on the large screens. As another example, when the large screens show a clip or still of a special moment in the game, such as a touchdown or a strike or home run, they may show a fan's reaction together with an invitation for others to order similar or other images.

The system may collect and use a customer database. For example, if a customer has a season seat, the system can keep the customer logged in without requiring a new log-in at each game, and can send promotional preview images to that customer's device during the game in the hope that the customer will like and order some of them. If a customer has logged in on a previous occasion, such as a previous game, the system can maintain the information and prompt the customer to supply a location during a current game by a message to the customer's device, in the expectation that the customer is attending the current game as well. Or, the system can automatically ascertain if the customer is in attendance, for example by a facial recognition algorithm that scans images taken during the current game or at stadium entrances or by an electronic system detecting the presence of the customer's device in the stadium. This patent specification describes systems and methods for capturing digital images of a customer or customer-related scenes in a defined location, such as a museum, a garden or park, a zoo, a religious institution, a theme park, a cruise ship, a resort, a hotel, a resort such as a Las Vegas hotel or other venue, or any venue in connection with which mementos may be desired that include customer-related images and possibly sounds. The systems and methods provide a customer with a pictorial souvenir of a visit to the site that may not be possible or practical otherwise. The souvenir can include other elements, such as “stock” images, images or sounds that may or may not include the customer but are related to the customer experience that is memorialized in the souvenir album, descriptive verbiage or other indicia, and other material. For example, at a resort area such as Las Vegas there can be a similar system of automated cameras, computer systems, and if desired kiosks as well, so that visitors can have images taken at photo opportunity sites in a way that may not be convenient to take with personal cameras, and in order to receive pictorial souvenirs with richer content than personally taken photos or videos can provide. Similarly, a cruise ship can be equipped with the system described in detail here primarily for stadiums, with similar benefits and opportunities for customers.

In variations and specifics discussed below, the systems and methods described in this patent specification can establish a customer identification and link it with a computerized central system, and specifically with a customer folder that will contain, or already contains, images and possibly sounds related to the customer experience in or about the relevant venue. The professional quality images related to the customer that the system and methods take automatically or through human representatives, and any sounds related to the customer, go to that folder. The systems and methods take at least some of the images and sounds at the customer's specific request, and at the place and time the customer specifically requests, thereby allowing the customer to determine where and when to pose for images and to record sounds. The systems and methods can afford the customer an opportunity to preview and edit the results, possibly iteratively, and to select results for inclusion in a professional quality album that the system creates and provides to the customer, with appropriate compensation arrangements for the central facility from the customer and possibly advertisers, and compensation for any individuals employed by the system or acting as independent contractors. As explained below, some examples use automated cameras and electronic contact with the customer and any human representative, contractor, or advertiser, and some use to some degrees human intermediaries between the customer and the central facility. Also as explained below, there is a variety of ways in which the customer's identity can be established and linked with the customer file in the central facility, some of which involve cards, or electronic devices, or similar identification aids given to the customer and some of which involve no such special aids but use the customer's smart phone or similar device to create the pertinent customer ID, to exchange information with the customer during the process, and even to deliver the final product, or one version of that product, to the customer, and to arrange for compensation. The customer ID and the link to the customer folder may be established without any aid that the customer carries, e.g., by using facial recognition technology or some other biometric process, or by the customer entering pertinent information into the system in some other way such as by using a keyboard linked to the central facility or by scanning or broadcasting information from a credit card or some other item that the customer already has.

One example where the new systems and methods are particularly suitable is using wide-angle, high resolution cameras at sites such as stadiums, and venues or events where crowds congregate, such as Times Square or a Marathon race, a theme park, a park such as Central Park in New York, N.Y., and the like. Using a personal device such as a smart phone or a special purpose device, the customer can request images of scenes that involve the customer or are otherwise customer-related. The customer location and images and portions thereof that involve the customer or customer-related scenes are identified at a computerized central facility using a seat number that the customer can provide through her/his personal device, or other technology such as GPS or other electronic tracking, or face recognition and tracking. The customer device can record related audio using the personal device or another device, and the audio can be edited and integrated with images in an album, video clip, or other souvenir material. Through interactive control involving the customer device, the customer can request images and the time when the images are taken (e.g., when posing as desired, alone or with a group), request related images (e.g., of a playing field or another scene), control the acquisition of related sound, receive proof images and sound from the computerized central facility, and select some for an album. The computerized central facility processes the customer requests and selections, controls the automated cameras, edits images and sound, assembles an electronic folder or portfolio, arranges for payment and delivery of results, and delivers results to the customer or a customer designee electronically or as a physical object such as a hard copy or media such as optical discs and flash drives.

Another example is creating a visual souvenir is applying the systems and methods described in this patent specification to a travel venue such as an airliner, a ship, or a train. The visual souvenir can include images of the customer taken under customer control on-board with automated cameras and coordinated with other images and with sound such as images of scenes associated with the customer's location and taken by other automated cameras or provided from stock.

Yet another example is a dedicated facility for automatically taking images and possibly recording related sound under customer control and without a need for professional attendants at sites and events such as weddings, charity functions, and other social or religious or other events. The facility includes automated cameras and lighting and possibly audio recording, which the customers activate and control though dedicated equipment or through personal devices such as smart phones. The facility can include large screens that show the scene so customers can arrange and pose for a capture of a still or video image, and can show the captured images so that the customers can select all or only some for an album. Alternatively, proof images and sound can be sent to the customers' personal devices for selection. The facility is automated to assemble the customer selected images and sound, and possibly other customer-related images and sounds into an album, deliver the results to the customers as described above, and arrange payment.

Yet another example is use in venues such as museums, libraries, and similar facilities. Applying the new systems and methods in such venues can involve customer control over when and where images are taken with automated cameras and lighting, using personal devices such as smart phones or interface devices provided through the venue such as buttons or portable devices or built-in touch screens or keyboards. In addition to customer images, the computerized central facility can include in a customer album material such as images of art or other objects, text and audio that the customer has requested or the central facility has offered to the customer. Upon interactive customer selection and approval, the central facility assembles and delivers albums to the customers as described above.

An alternative application of the new systems and methods involves participation by human representatives who can initiate contact with the customers, take some or all of the customer-related images, and help in the customers' interaction with the computerized central facility for viewing proofs, selecting material for albums, and arrangements for payment and delivery of product. The alternative can apply to any number of venues where one human representative can take images at a given location and others can take images at other locations, or the same human representative can move to different places in the venue or between venues. After initial contact with a customer, the human representative can establish a relationship between the customer identity and images that will be taken for that customer. For example, the representative can hand a ticket with a number and/or some other indicia such as bar code to the customer and can take a photo of that ticket or scan the ticket with an optical or magnetic reader, thereby entering the customer ID in the representative's camera or associated device and/or transmitting it to the central facility. As an alternative, an electronic connection can be established wirelessly between a customer device such as a smart phone and equipment carried by the representative and/or located at the central facility and a hand-shaking exchange can take place over that connection that associates the customer's ID with an electronic folder or portfolio of images that will be taken of or for the customer. The representative then takes images that the customer requests or agrees to, and stores them in his/her camera or associated equipment and/or sends them to the central facility for storage in a manner that associates them with the customer ID. The customer can see proof images on (i) a customer device such as a smart phone to which the representative or the central facility transmits them electronically, (ii) on the representative's camera or other equipment, (iii) on screen(s) located at or near the place(s) where the images were taken, or (iv) through some other process or equipment. Through the representative's equipment or through other equipment, the customer can select some of the images for inclusion in an album and can edit some or request editing such as cropping, darkening or lightening, etc. After possibly repeated interaction, if any, the system assembles an electronic folder or portfolio of the images, and possibly adds other images and other material such as text and sound. After further customer review, if desired and provided, a final product is assembled in the form of an album or other personalized item that may be delivered to the customer or the customers designee in electronic form through an electronic transmission and/or in other ways, such as a hard copy or an electronic storage medium.

In the example of using the system in New York's Central Park, the proof images may be shown at kiosks that are at strategic locations such as park exits or at or near famous sites such as Bethesda Fountain or the Band Shell. The kiosks can be permanent structures or mobile carts, and can include both facilities for showing and editing/selecting images and facilities for generating the final product such as high-quality printers and binders that can produce a personalized album far a customer and/or an album on an optical or other storage medium. Payment can be arranged with the representative, e.g., with a credit card read by a reader that the representative carries, with the kiosk, or wirelessly through a customer device such as a smart phone, all involving transfer of the pertinent information to the central computerized facility and back to the customer for confirmation.

When human representatives are involved, they can be employees of an organization operating the system described in this patent specification, or they can be independent contractors who are provided with software that enables the operations described above. This software can run on camera equipment that the contractor carries, provided it has the requisite capabilities, or on separate but associated equipment such as a tablet computer or a sufficiently capable smart phone. In each case the equipment and software enable two-way transmission of pertinent images and information between the contractor and the central facility.

One issue with showing proof images to customers so they can select/edit images is that the images should be of good quality to serve their function and yet the customer should still have an incentive to replace them with the final, paid product that the system creates. To this end, the system can provide a disincentive to keeping the proof images in preference to ordering and paying for a final product. Many ways are contemplated for this purpose in the system and method of this patent specification. For example, the proof images provided to a customer device such as a smart phone, tablet or computer can be “vanishing” images that fade away after a preset time and/or according to some other parameter such as number of viewings. The proof images in electronic form can be provided with marks such as writing or some other indicia that are always shown or show from time to time, and they can be provided with associated measures that prevent storing them in device memory and transmitting them from the customer device. Any of the known and future means for preventing or making it more difficult for the customer to print, store, or re-transmit some or all of the proof images, or use the proof images for other than the intended purpose, are contemplated for use in the systems and methods of this patent specification.

These and other features and aspects of the new system and method are illustrated in the drawings briefly described below and from the more detailed description of preferred embodiments that follows. The drawing are solely for the purpose of illustration and description; they are not to scale and do not show every feature or detail, and are not intended as a definition of the limits of the claimed inventions. Features, components, elements, and steps that are illustrated in one figure or are described in one example or embodiment of the new systems and methods can be used together with and in combination with features, components, elements, and steps that are illustrated in another figure(s) or are described in other example(s) or embodiment(s).

### BRIEF DESCRIPTION OF THE DRAWINGS

FIG. 1A is a block diagram illustrating a system according to one embodiment described in the specification.

FIG. 1B is a flow chart illustrating main steps on the operation of the system of FIG. 1A.

FIG. 1C is a system schematic of an example of an image capture system for use in a defined location.

FIGS. 2A-2B form a flowchart of exemplary methods of capturing an image in a defined location.

FIG. 3 is a system schematic of another example of an image capture system.

FIGS. 4A-4D form a flowchart of another exemplary method of capturing an image in a defined location.

FIG. 5 is a system schematic of a further example of an image capture system for use in a defined time period.

FIGS. 6A-6B form a flowchart of exemplary methods of capturing an image in a defined time period.

FIG. 7 is a flow chart illustrating features and steps of a system and method for providing customized, customer-controlled albums.

### DETAILED DESCRIPTION OF PREFERRED EMBODIMENTS

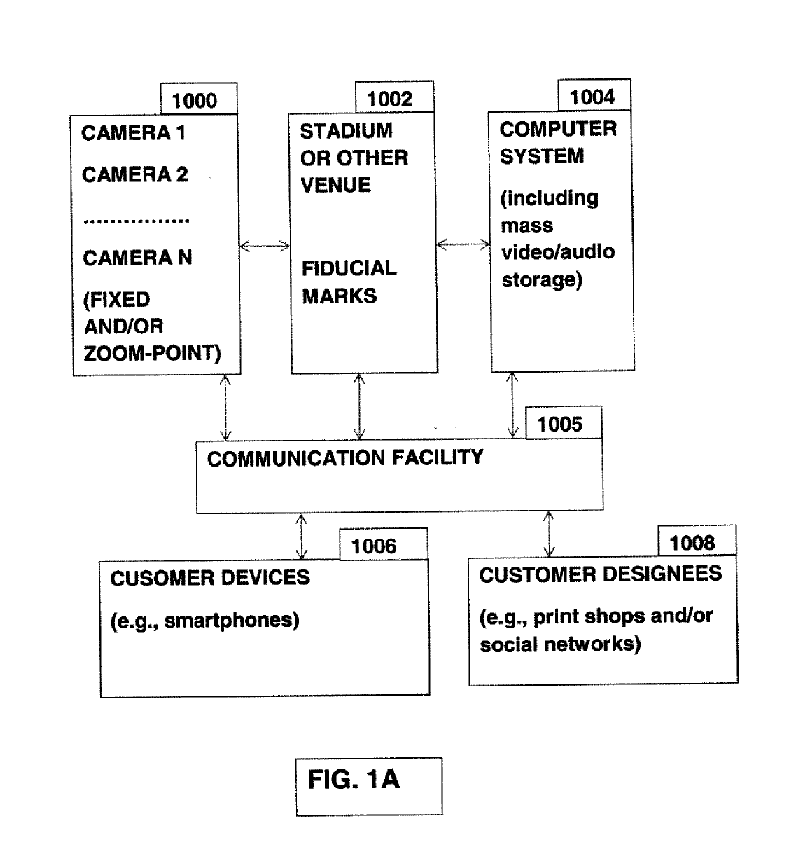

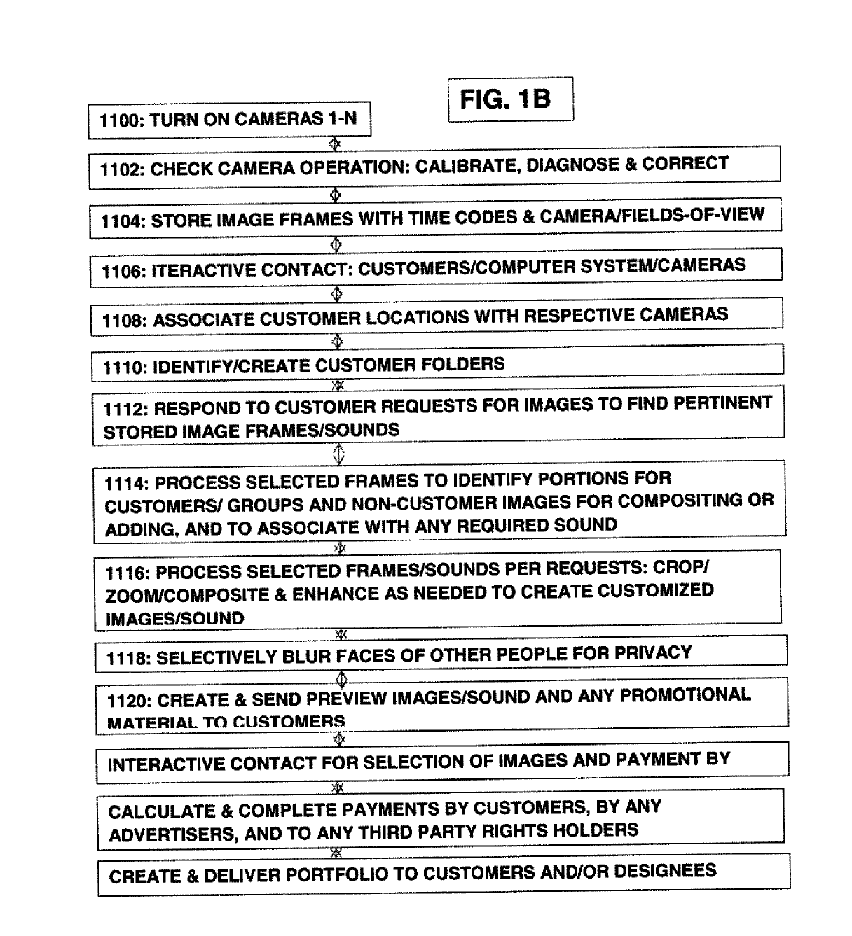

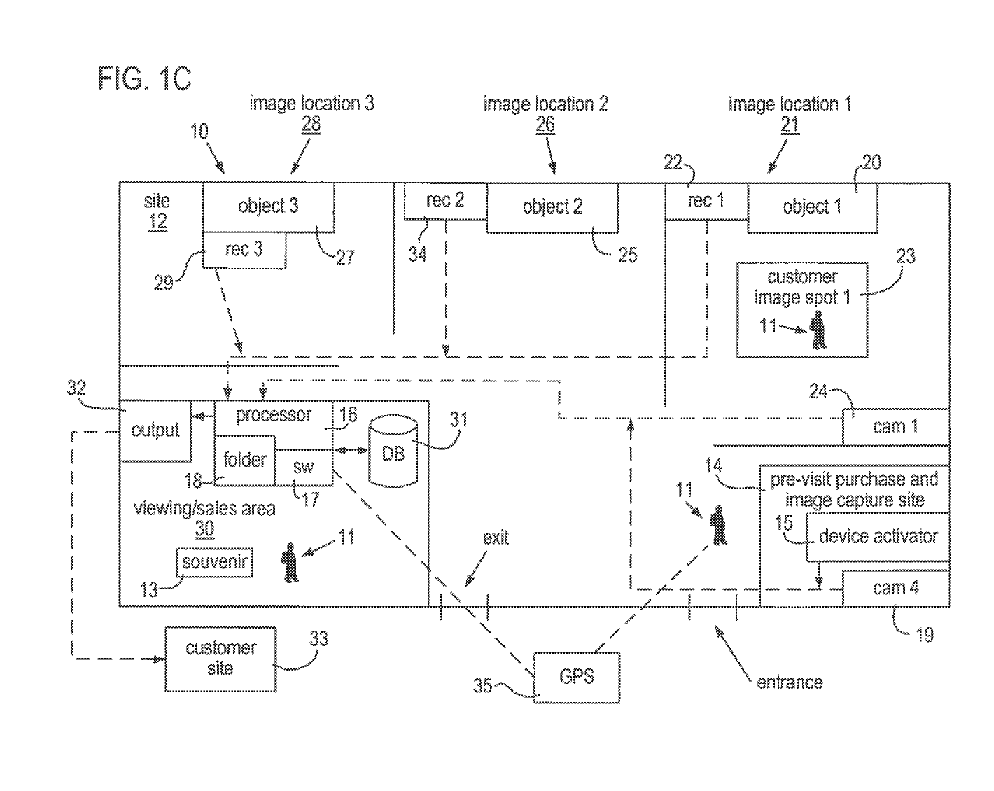

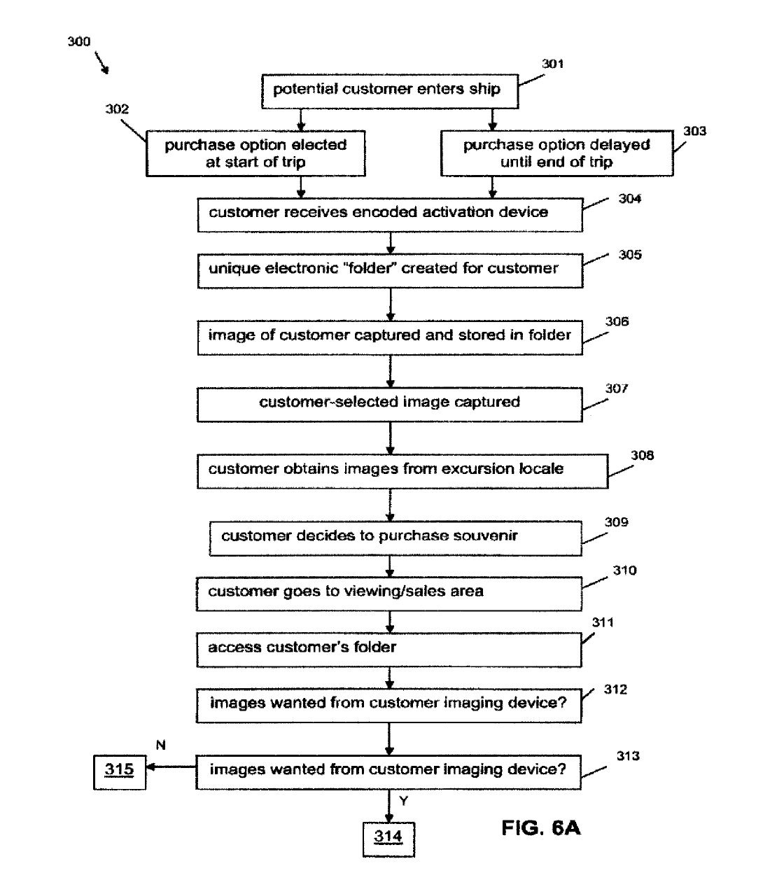

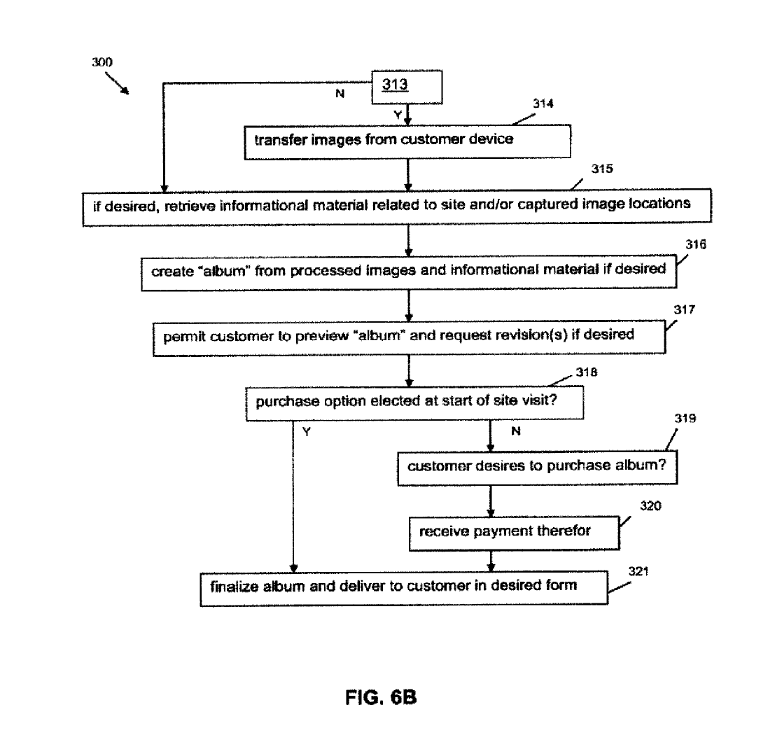

A description of preferred embodiments of the present invention will now be presented with reference to FIGS. 1A-7.

As seen in FIG. 1A, a system that is particularly suitable for venues such as a stadium 1002 but also is useful for other venues comprises cameras 1000, which comprise cameras 1-N (where N is a positive integer) that preferably are at fixed locations and preferably are very high resolution, wide field of view video cameras. One example has been previewed by Panasonic under the model designation AW-HEW 120×4, but other camera systems can be used in a particular implementation of the system described in this patent specification. Each camera views a respective portion of the stadium, and the fields of view overlap to some extent so that any one group of people that may want to be in the same image is within the field of view of at least one camera and preferably within the fields of view of several cameras from respective different angles. One or more cameras also can view and image the game in the stadium field. Sufficient redundancy of cameras can be provided to ensure that the failure of one or a few will not unacceptably degrade coverage of area that should be imaged. At least some of the cameras can be capable of zooming in and out optically under computer control, and can be mounted for pointing in a specified direction, and possibly using pan/tilt motion, under computer control.

When a camera is in a fixed position a point in the field of view such as any of seats 1-M in the stadium (where M is a positive integer and may be designated by multi-character code) should correspond uniquely to a point or pixel group in each image taken with that camera. To assist in initial settings and in calibration if needed, fiducials can be provided at known locations in the stadium such as signs, color plates, numbers on columns, etc. that will be imaged by a camera so that any location in the field of view of that camera can be found in the image in relation to the imaged fiducials.

A computer system 1004 controls the cameras and may also control other systems such as a lighting system in the stadium, large displays visible to the public in the stadium, audio systems, etc., and communicates with customer devices 1006 such as smartphones and with customer designees such as print shops. A smartphone such as an iPhone of an Android phone is an example of a customer device, but other customer devices can be used instead of or in addition, such as keypads on seats, custom wireless device that can be distributed to customers for use in the stadium, etc. Preferably, the communication between computer system 1004 and customer devices 1006 and/or designees 1008 is wireless, using protocols such as messaging, email, or a special application customized for the purpose, but wired communications of some or all the relevant information are possible.

FIG. 1B illustrates main steps in the operation of the system of FIG. 1A. In step 1100, computer system 1004 turns ON cameras 1000 and any appropriate lighting, for example when the stadium first opens for a game, or just before the game starts, or at some other desired time. In step 1102, computer system 1004 can run a system check that includes checking camera operation and carrying out any calibration and diagnostics, and taking necessary corrective actions. Because preferably the system includes redundancies in the number of cameras and their fields of view, even if one or a few cameras are not operational, the overall system can still perform by using the operational cameras to cover all sections of the stadium and the game, although not necessarily from all the angles that the full set of cameras provides. The initial check also can include checking computer system 1004, for example to confirm that the camera outputs are being recorded, that image frame storage servers used for the purpose operate as needed, and that image processing facilities and audio processing facilities and communication facilities operate as required. If zoom and pointing facilities are provided for a camera, these capabilities also can be checked in this step and any needed corrective actions taken. Following the system check, which can be optional and can be invoked automatically at specified times or event or at operator commands, in step 1104 the camera outputs are stored, with time codes or other unique notation to identify the individual frames or groups of frames and with identification of the respective cameras. Because of the amount of information, typically RAID storage systems (Redundant Array of Inexpensive Discs) can be used, and/or optical discs. Preferably, the image information is stored at full resolution, but some compression can be used provided it is lossless or at least allows images of individual people in the stadium to be recovered with decompression and zooming with adequate image quality to satisfy the design goals of the system.

In step 1106 interactive contact between customer devices 1006 and computer system 1004 provides the computer system with identifications of customers, their locations in the stadium, and possibly other information as described below. For example, if a customer has had previous contact with the computer system, for example at a previous game or from logging into the computer system before the game, the computer system can have a customer folder so that a single telephone call or other message from the customer can inform the system who is the customer and associate the customer with a pre-existing customer folder. In the course of the telephone or other contact, computer system 1004 can ask the customer to say or key in the customer's seat number. The customer's response can enable the computer system to associate the customer folder with a location in the stadium for the purposes of the current game or other event. If the customer has had no previous contact with the computer system or has not previously logged into the system, the customer can do that by a phone call or other messages to the system and by answering automated questions of keying in information about the customer's identity and location in the stadium. In addition, the customer can identify a credit card or other chargeable instrument that can be charged for images or other material that the customer requests. The log in can be without a special application, by simple telephone contact or email or message operations, or it can use a special application that the customer can download, for example in response to prompts that can be displayed at the stadium or provided in material distributed at the stadium, or at an earlier time. Other ways can be used to provide the computer system with the identification and location of customers. For example, the computer system can use facial recognition technology to analyze camera outputs to identify and locate customers known to the system from previous contacts, or known season ticket holders locations, or keypads at seats through which customers can log in, or any other technology that can provide the system with the identity and location of customers who may request images, and possible additional pertinent information.

Based on knowing the locations of respective customers, in step 1108 computer system 1004 associates customers with cameras and thus with content of RAID or other storage facilities for images from those cameras. This can be based on information stored in the computer system on which camera covers which seats in the stadium. In step 1110, computer system 1004 identifies existing customer folders for customers that have previously used the system, or creates new customer folders for other customers who have been logged in for the event at the stadium. A customer folder can be a location in storage in computer system 1004 that contains or will contain customer identification information such as name, charging instrument such as credit card, location in the stadium, any requests for images/sound, any requested images, other images or material that will be composited with or added to requested images, and possible historical information about the customer that can help computer system 1004 select ads or promotional material or other material to offer or deliver to the customer.

In step 1112, computer system 1004 responds to requests from customers for images/sounds. Again, the requests can be sent wirelessly, such as from a customer smartphone or other customer device. Preferably they are sent as simple commands by tapping symbols on a touch screen or keyboard entries, but can be oral command or requests that computer system 1104 can interpret through voice recognition technology, and can be in response to voice or message prompts for specific information sent to a customer's smartphone from computer system 1004. A customer request can be for images taken in the past, e.g., so many seconds of minutes ago, or images associated with events such as at the time of a touchdown or a home run or so many second before, during or after. A request can be for the present, or for so many seconds from now—so that a customer can pose for an image. Game statistics or other information about the game or event or the venue can be added to the images to improve their souvenir value, for which an extra charge can be made to customers or they can be added as a bonus feature. Or, a request can be for a future time or event, such as a request for an image or images so many seconds or minutes from now, or for images at the time of an expected event such as a touchdown or home run, or at the time a player comes to leaves the field, or any other event that computer system 1004 and its operators can recognize. A request can be for images of a single customer or for a group of customers, such as for images of the customer and so many seats to the left and/or right of the customer or around the customer. A request also can be for composited images that include the customer or a group of customers and a landmark such as a view of the stadium, or composited images that include a player, a team, a logo, or a scene from a game, or some other image. A request also can be for images of other material that does not include the customer, such as images of a venue, players, teams, etc. And, a request can ask for images that involve zooming in and/or out, for example a clip that starts with an overall view of the stadium or the playing field, zooms in to a customer or a small group, and again zooms out to a larger area. These are only examples, and a request can be for any audio/visual material that computer system 1004 can provide. Audio material may come for a customer device, such as the microphone of a smartphone connected with computer system 1004 and monitored thereby and stored in the customer folder, or it may come from other sources such as microphones in the stadium recording the crowds or some other source of contemporaneous sound, or from stock sound such as music,

In step 1114 computer system 1004 processes the customer requests to identify image frames that contain images that customers have requested. This includes images from respective cameras 1-N as well as stock images that customers may have requested for compositing with or adding to customer images. This processing involves mapping requests to cameras based on customer locations associated with requests, then mapping customer locations to portions of image frames, and selecting any other images for compositing or adding to customer images. If a customer requested images involving zooming in/out, computer system 1004 can process such a request in several ways. One is to carry out an entirely electronic process in which different portions of the frames in a video clip are used for different degrees of zooming. Another is to control a camera 1000 with optical zooming capabilities to carry out some of the required zooming. Vet another is combination of optical and electronic zooming. The processing in step 1114 also involves processing any sound that should be included, such as time-synching sound from a customer's smartphone or some other source to images. The result of step 1114 is a selection of frames/sounds that a customer has requested and possibly also frames, sounds, or other material that computer system 1004 has identified as being of actual or possible interest to the customer that will be offered or delivered to the customer.

In step 1116, computer system 1004 processes the selected image frames and possibly sounds to prepare images/sounds to offer to customers. In the case of a selected image frame, this processing involves mapping the customer location to a pixel set in the image to effectively zoom in on the customer's image, and possibly magnifying this pixel set to the desired image size, for example by using interpolation. If the customer request is for an image that includes people in addition to the customer or the customer's group, for example in images that involve zooming, the processing can include identifying such images and marking them for processing to blur faces of other people to take into account privacy concerns. If a customer request composited images, the processing in step 1116 includes retrieving images for compositing and compositing them with the customer's image using known compositing techniques such a used in Photoshop from Adobe. The images for compositing can be stock images that computer system 1004 stores, such as images of the stadium or some other landmark, or a team, or a logo, or they can be images from the current or past games, or any other images that do not include the current images of the customer or a customer group. If the request includes images to be added to customer or composited images, such as scenes from a game or images of venues or players, computer system retrieves them and adds them to the customer folder. Any required sound is associated with the images in this processing and added to the customer folder. The images/sounds for compositing or adding to the customer folder can be in response to explicit or implicit request from a customer and/or in response to determinations made by computer system 1004 regarding what images/sounds can be offered to the customer, based on information that computer system has about the customer, about a class of customers, and/or some other factors. The algorithms for making such selections can be similar to those used by search websites such as Google and Bing to offer material that a user has not explicitly requested but the search engine has determined has some likelihood to be of interest to the customer. The result of step 1116 is customer folders containing respective sets of images/sounds that can be offered to each customer.

In step 1118, computer system further processes the customer folders as required to blur or otherwise obscure faces, if needed to account for privacy concerns of people other than the customer requesting the images/sounds in that customer's folder and a group of the customer's friends of associates sitting nearby. Blocking or blurring of faces can be optional, with an opportunity for customers to opt in or out. If the computer system stores images including all faces in the field of view, the possibility for later retrieval is preserved. At the request of customers, transmitted to the computer system from their personal devices as one example, the system can automatically transmit customer images to customer-designated social media addresses, such as Facebook. Blurring or de-focusing techniques are known and need not be described in detail in this patent specification.

In step 1120, computer system 1004 creates material for sending to customers as previews. In this process, the computer system accesses a customer's folder that has been populated as described above, and assembles the material in a form that can be sent to the customer for review and selection of images/sounds that the customer would purchase. This material preferably is in a form that would encourage the customer to purchase some or all of it rather than simply view and possibly attempt to store that material. For example, the material can be in resolution that is sufficient to view on a small screen such as a smartphone screen but not to view on a larger screen or print, or the material can be encoded to disappear from the customer's device after a set time, or to prevent the customer from storing or transmitting the preview material, or the material can be marked with notation or other marks that indicate it is only for preview, or can be treated in some other way that differentiates the preview material from images for purchasing. The preview material also can include promotional material such as offers of discounts for purchasing images/sounds or for other purchases, coupons for use with the system or for other purposes, free material and items, ads, and the like.

In step 1122, computer system 1004 interactively communicates with customer devices 1006, again preferably but not necessarily wirelessly, to determine what images/sound or other material a customer will select for purchase from the preview material the customer has received. For example, each image or clip can be delivered to a customer device together with a box to check for purchase or for deletion, and transmit back to computer system 1004. As another example, image/sound editing can be enabled at the customer devices wherein a customer can delete images/sounds, including individual frames or clips from video images, or crop images, or change brightness, etc., using facilities such as image editing facilities available on some smartphones. As yet another example, images can be delivered to a kiosk or some other location where a customer can preview a display of the images after providing a unique customer identity such as a bar code, a number, or any other suitable identification that the system can recognize. The preview material preferably includes pricing information, and options for delivery of the purchased material, such as sending electronic versions to a customer device and/or to another site designated by the customer, such as friend or relative or a social network or picture storage site or a print facility. The pricing information preferably informs the customer about respective pricing of different delivery options, including for creating various kinds of customized portfolios in electronic form and/or in paper form and binding, and about the inclusion of composited images/sounds or additional images/sounds for which payment to third party rights holders may be required. Also in step 1122, a customer confirms a payment mode, e.g. by a credit card, or otherwise informs computer system 1004 how to charge for delivering the selected images/sounds in final form. The result of step 1122 includes information transmitted to computer system 1004 that identifies the material that a customer has decided to purchase and the way the customer will be charged for the purchase.

In step 1124, computer system 1004 uses the information that a customer has provided in step 1122 to calculate a charge to the customer to purchased images/sounds, any payments to thirds parties for images/sounds included in the material that the customer has purchased, and any charges to advertisers for ads included in the material that was or will be sent to the customer. Again, such calculations can use known technology used by entities delivering content over the Internet, such as Apple, Amazon, and others, and charging customers for delivered material. The result of step 1124 is information identifying what material should be delivered to a customer in final form and how, a completed charge to the customers payment instrument such as a credit card, and an identification of any payments to or from third parties for the material to be delivered in final form to the customer.

In step 1126, computer system 1004 creates a folder for delivery to a customer and/or the customer's designees and makes the delivery. The material includes the final form of images/sounds that the customer has selected in step 1122 or the system has determined should be delivered to the customer, and any promotional material that the system may have determined should be sent to the customer. The delivery mode can be electronic and/or hard copy, for example a bound booklet of some or all of the images and/or media storing sound, and possibly other souvenirs. The electronic delivery can be to the customer's device, to other electronic addresses specified by the customer, to social media or other sites associated with the customer, to print shops or other print and/or book binding facilities, etc.

For conciseness, the system operation described above omits conventional steps that a skilled computer software designer or programmer would know how to implement, and gives an example of a sequence of steps that need not be performed in the illustrated order, and do not require the full set of illustrated steps to be performed in every use of the system. As a nonlimiting example, step 1102 can be omitted on occasion, and step 1104 can start after steps 1106 and 1108. Hardware/software system designers and programmers can implement specific examples of the disclosed system and operation without undue experimentation according to the description in this patent specification and can select specific design goals and tradeoffs in cost, performance, and other factors.

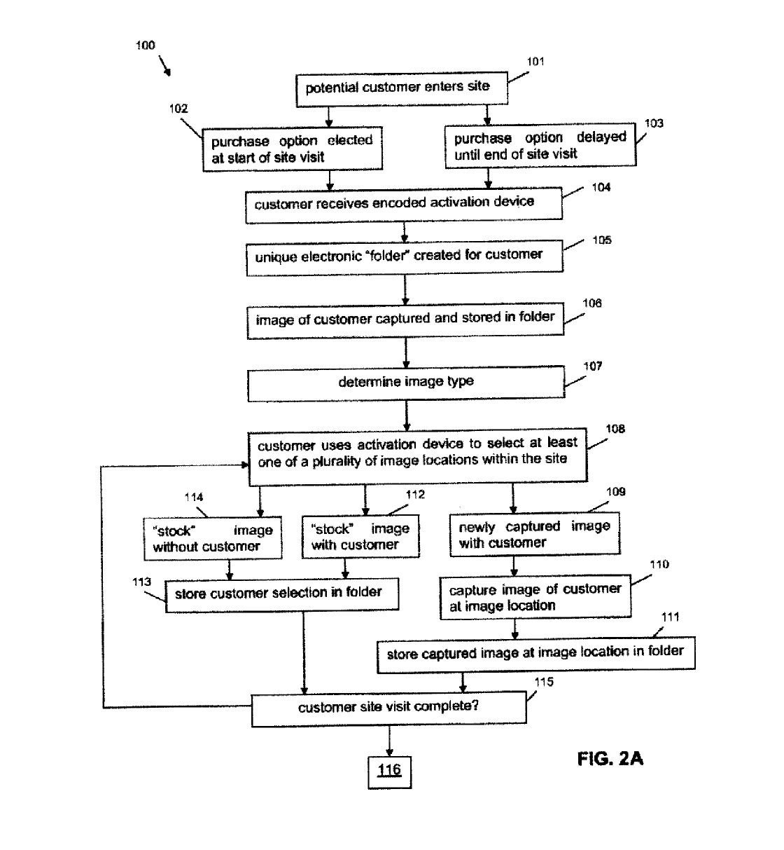

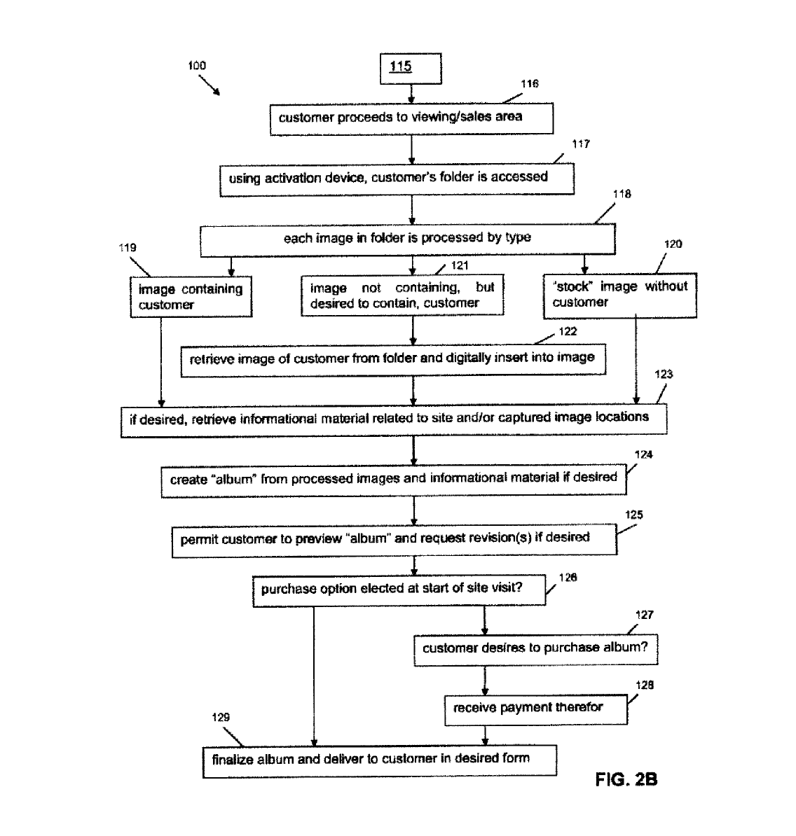

FIG. 1C illustrates another example of a system for creating and delivering images/sounds to a customer, and FIGS. 2AA and 2B illustrate an associated method A system 10 and method 100 capture a digital image of a customer 11 in a defined location or venue. The system 10 and method 100 are preferably for use in a defined location, venue, or site 12, such as, but not intended to be limited to, a museum, a garden, a zoo, a religious institution, a theme park, a resort, a hotel, a stadium, a sports event, an airplane, a ship, a train, a public space, or any other site or venue where images can be taken. The system 10 and method 100 provide a customer with a professional quality pictorial souvenir 13 of a visit to the site 12. It will be understood by one of skill in the art that the words picture, image, camera, and photograph are not intended to be limited to a particular construction or equipment, and that still and moving images and recording devices can be contemplated thereby, and may include other media such as sound.

In a particular embodiment, a potential customer 11 enters a site 12 that has been outfitted with components for creating a pictorial memento 13 of the visit (block 101). The opportunity to purchase this souvenir 13 can be offered to the customer 11 upon entering the site 12, for example, at a pre-visit purchase and image capture site 14, an offer that can be accepted (block 102) or rejected (block 103) by the customer 11. In either case, the customer 11 can be given an encoded activation device 15 (block 104), which can comprise, for example, a card with a readable magnetic stripe such as known in the art. This device can also comprise the customer's cell phone or a remote control device, or any other such device capable of transmitting a signal.

A protocol is established for communication between the activation device 15 and a processor 16, which has software 17 for creating a folder 18 specific to the customer 11 (block 105). In one embodiment, an initial image of the customer 11 can be captured by an intake camera 19 and stored in the folder (block 106), for example, using “green screen” technology so that the customer's image can be embedded subsequently in other images if desired.

As the customer 11 is touring the site 12, s/he may desire to capture an image of and/or with an object at the site 12 (block 107). There are several ways in which this may be accomplished, although these examples are not intended to be limiting. In one case, the customer 11 may desire to be imaged with a first object 20 at a first image location 21 (block 109). The customer 11 uses the activation device 15 to contact a first receiver 22 (block 108), which is in signal communication with the processor 16. A first customer image spot 23 is indicated near the first object 20, and a first image location camera 24 images the customer 11 (block 110) and transmits the image to the processor 16, which stores the image in the customer's folder 18 (block 111).

Another option includes the customer 11 desiring his/her image to be inserted into a scene with a second object 25, for example, at a second location 26 (block 112). Again, the customer 11 uses the activation device 15 to contact a second receiver 34, which communicates the customer's order to the processor 16, which stores the order in the folder 18 (block 113).

A further option includes the customer 11 desiring a reproduction of an image of a third object 27 at a third image location 28, without the customer image therein (block 114). The customer 11 uses the activation device 15 to contact a third receiver 29, which communicates this order to the processor 16, which in turn stores the order in the folder 18 (block 113).

In some embodiments it may be desirable that the camera 24 be placed so as to capture an object that can move, for example, a ride in an amusement park, a performer, or an animal in a zoo. In this case, the camera 24 may be mounted for movement on a platform 36 that can be placed in signal communication with the activation device 15. This configuration would permit the customer 11 to control movement of camera 24 to capture a desired object within range of the camera's panning ability.

It will be understood by one of skill in the art that other methods of communication and customer identification can be used. For example, instead of having an activation device 15, one or more forms of biometric identification could inform the system as to the customer's identity, such as, but not intended to be limited to, fingerprint, iris scan, and facial recognition. Additional data can be collected to increase the chance that the system will recognize a particular customer, such as searching for a particular item of clothing or color worn by the customer, imaging more than one customer at a time (for example, a companion), or imaging a numerical identifier worn by the customer.

In addition, the location of the customer can be determined “passively,” by GPS 35 sensing of the customer's activation device 15, or by some other electronic way to identify the position of device 15 based on emissions from the device or some other detectable parameter of the device. This option also permits the system to sense the customer's location and associate the location with data stored in a database 31 in signal communication with the processor 16.

In another embodiment, the image location 21, 26, 28 could have signage indicating a telephone number for the customer to call. The system could then use the call 10 from the customer's telephone to associate the customer's folder 18 with the location 21, 26, 28. Yet another way is to have the customer supply the pertinent location, e.g., a seat number, through a cell phone call or some other communication to the central facility.

This process can be repeated until the customer's visit is complete (block 115), at which time s/he can proceed to the viewing/sales area 30 (block 116) if desired. Using the activation device 15, the customer's folder 18 is accessed (block 117). Each image and order in the folder 18 is processed according to type (block 118). An image containing a customer 11 is retrieved from the folder 18 (block 119), and a “stock” image without the customer 11 is retrieved from the database 31 (block 120). For those images wherein the customer 11 wishes to be inserted (block 121), the associated “stock” image is retrieved from the database 31, and the customer's image, as taken in step 106, is inserted thereinto digitally to form composited images, for example by using technology similar to that of Adobe's Photoshop (block 122).

The customer 11 can also have the option to have the souvenir 13 enhanced with material stored in the database 31, such as informational textual material and/or additional images (block 123). For example, in a museum, didactic material relating to a particular objet d'art could be inserted. A complete “album” can then be digitally created (block 124), and the customer 11 can preview the album on an output device 32 and request revisions as desired (block 125). If sound is desired, the customer can help in recording sound in the device 15 that can be, for example, the customer's smart phone, and send it to the central facility for incorporation into a digital album that can be stored electronically or in computer-readable media. If the souvenir 13 had not been purchased at the start of the visit (block 124), and if the customer 11 wishes to purchase the souvenir 13 (block 127), payment is received (block 128).

The final souvenir 13 is then delivered to the customer 11 in one or more forms (block 129). For example, the souvenir 13 can take the form of a physical, printed album, which could be printed and bound on site. Alternatively, the souvenir 13 can take the form of a digital record, for example, stored on media. Further, the souvenir 13 can take the form of a digital record transmitted to the customer 11 at a desired site 33. The digital media and record can contain both still and moving images and sound, as desired, and alternatively or in addition can be sent to a customer's designee such as a friend or relative, an office, and a printing shop.

The final souvenir 13 can comprise multiple forms and components as desired. For example, an album could include material suitable for entertaining children, such as a coloring book, which would serve the purpose of being both amusing and educational.

Further, some of the cost of producing the souvenir 13 can be defrayed by including advertising. The advertising could be “stock,” that is, directly related to the site itself or the surrounding area (local restaurants, shops, etc.). Alternatively, the advertising could be targeted to the customer from data gleaned on customer demographics and customer preferences, as determined by the software 17 from the material selected by the customer. For example, if the customer is in a museum with dissimilar items, but the customer gravitates to a particular type of display (e.g., medieval art, Civil War, etc.), correlations can be made as to vendors and merchandise that might appeal to the customer. Such preferences can then be used, not only to select advertising to appear in the souvenir 13, but also for subsequent marketing opportunities to the customer via, for example, email or direct mail marketing campaigns.

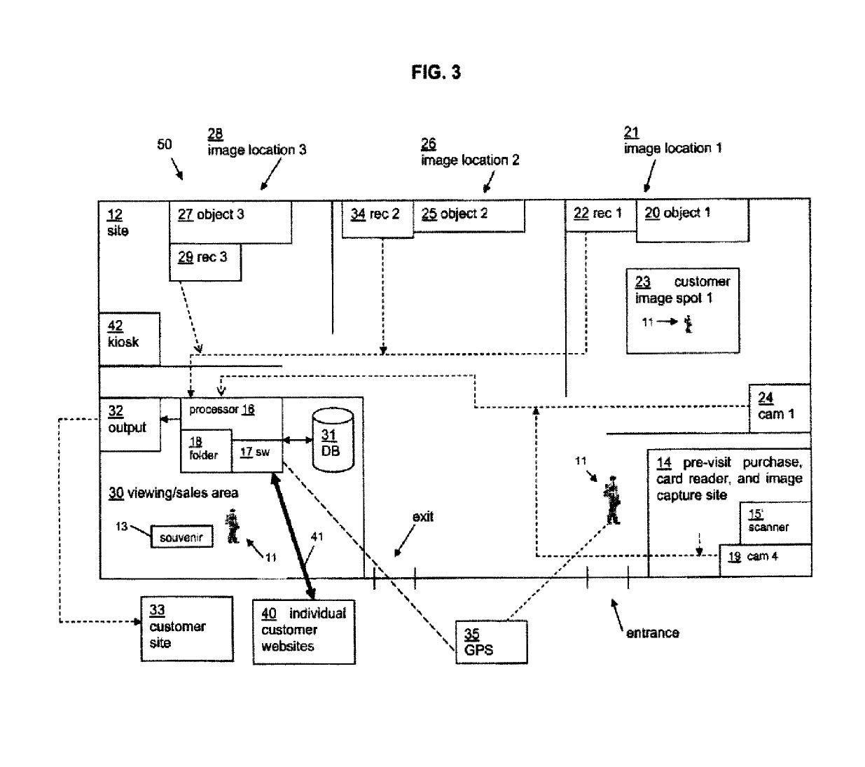

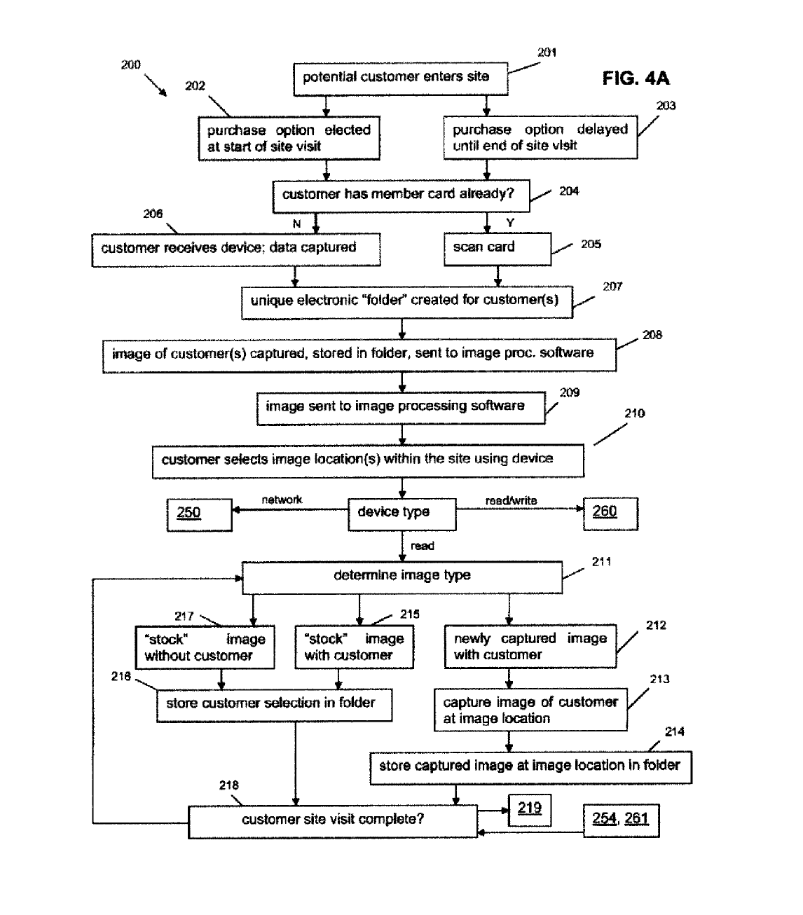

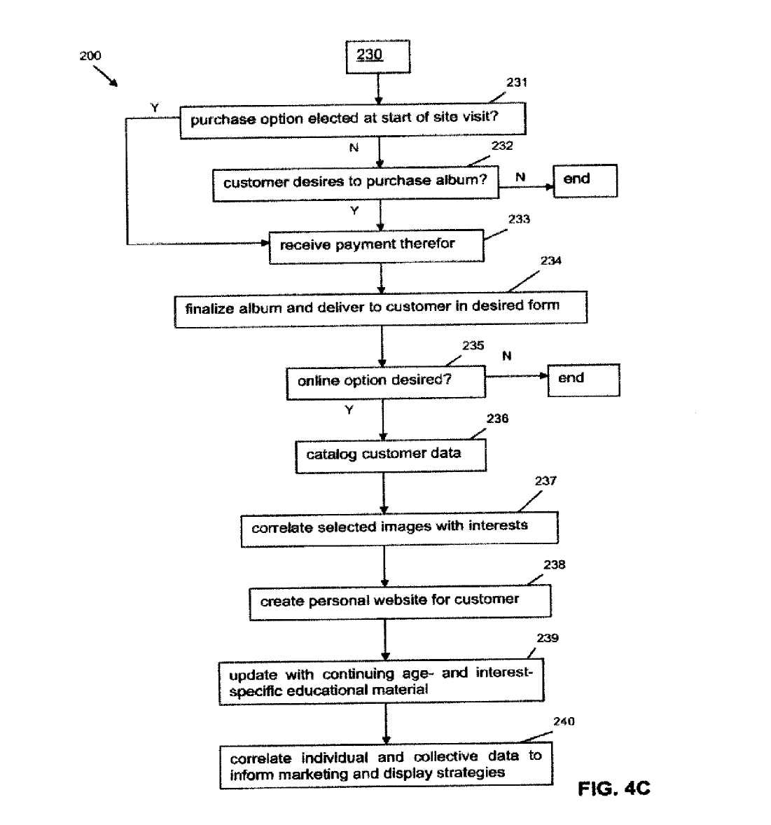

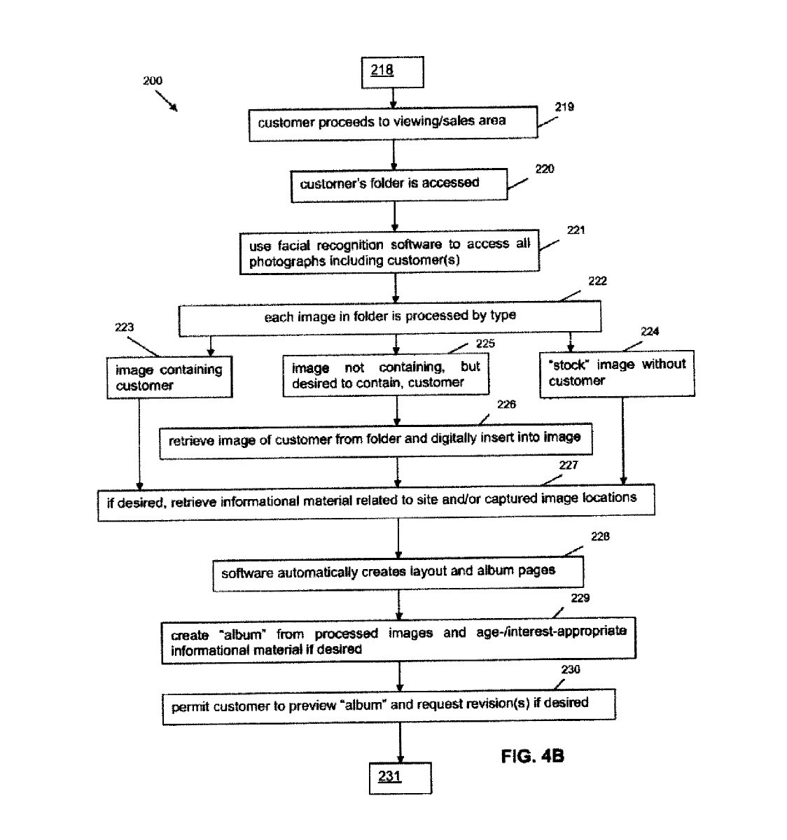

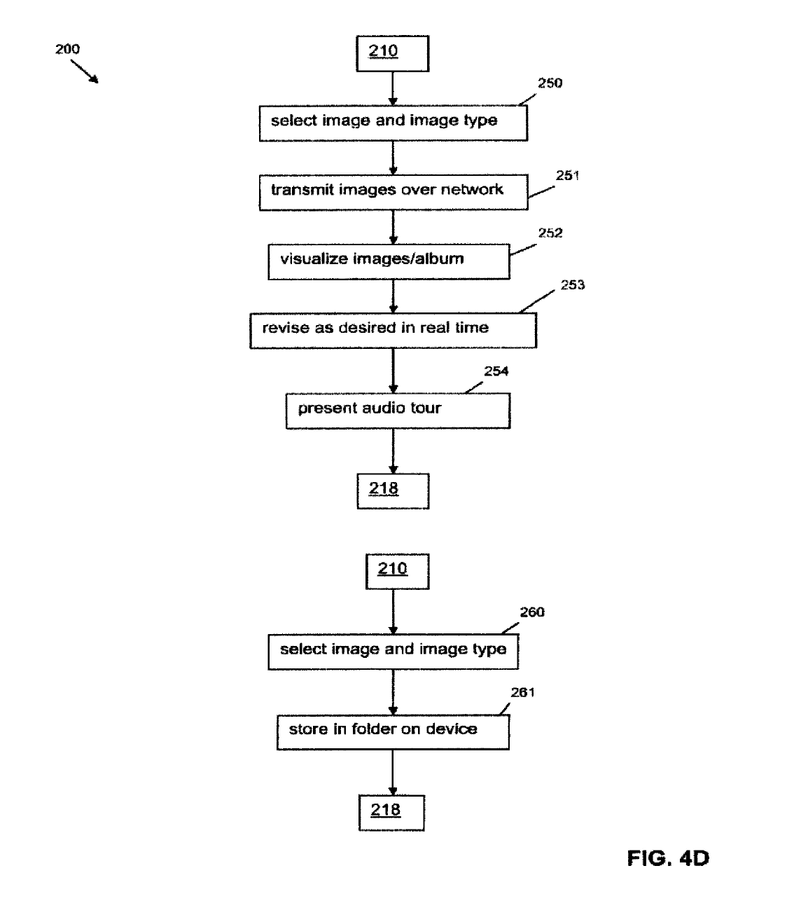

In another embodiment a system 50 (FIG. 3) for use in a defined location and a method 200 (FIGS. 4A-40) are provided that can embrace additional features. FIG. 3 is a system schematic that incorporates similar elements as in FIG. 1 discussed above, with common numerals indicative of common elements.

In the defined-location embodiment 50, 200, a potential customer 11 enters the site 12 that has a membership option (block 201). The opportunity to purchase a souvenir 13 can be offered to the customer 11 upon entering the site 12, as above, an offer that can be accepted (block 202) or rejected (block 203) by the customer 11. The customer 11 is queried as to whether s/he is already a member (block 204). If so, the customer's membership card or other device is read, for example, by scanning 15′ (block 205); otherwise, the customer receives a device such as a scannable card, and the customer's pertinent data are captured (block 206), which can include a photograph/image in some embodiments, and also can include data such as age, which will be used as a basis upon which to include such material as informational narrative. The word “card” is being used herein without limitation, and one of skill in the art will appreciate that any device that can communicate in such a way as to identify the user is intended to be subsumed herein. For example, a read-only or a read/write card could be used, with a magnetic strip such as known in the art. Further “smart” devices such as cellular telephones and media playing devices can also be used instead of or in addition to another type of card to identify the customer and serve to establish a link between the customer and the computerized central facility.

The software 17 creates a folder 18 specific to the customer 11 (block 207) linked to the customer ID. An image of the customer 11, which can comprise an image of the customer with those accompanying him/her, can be captured by the intake camera 19 and stored in the folder (block 208) and also sent to image-processing software (block 209).

As the customer 11 is touring the site 12, s/he may indicate a desire to capture an image of and/or with an object at the site 12 with the device (block 210). The selection and communication procedure can then proceed in at least two ways, which is determined by the type of device being used (block 210a) and the site configuration (block 211). For example, for a device that does not have “write” capabilities, the following steps are taken.

There are several ways in which the device may be used, although these examples are not intended to be limiting. In one case, the customer 11 may desire to be imaged with a first object 20 at a first image location 21 (block 212). The customer 11 uses his/her device to contact a first receiver 22, which is in signal communication with the processor 16. A first customer image spot 23 is indicated near the first object 20, which can be accomplished with visual means such as known in the art. Visual and/or audio means can also be used to “count down” until the shot is taken. A first image location camera 24 images the customer 11 (block 213) and transmits the image to the processor 16, which stores the image in the customer's folder 18 (block 214).

Another option includes the customer 11 desiring his/her image to be inserted into a scene with a second object 25, for example, at a second location 26 (block 215). Again, the customer 11 uses the device to contact a second receiver 34, which communicates the customer's order to the processor 16, which stores the order in the folder 18 (block 216).

A further option includes the customer 11 desiring a reproduction of an image of a third object 27 at a third image location 28, without the customer image therein (block 217). The customer 11 uses the device to contact a third receiver 29, which communicates this order to the processor 16, which in turn stores the order in the folder 18 (block 216).

In some large installations, particularly those that can become crowded, it may be difficult to approach certain popular objects. In such cases, a multi-purpose kiosk 42 having interactivity, via, for example, a touch screen, could be provided wherein a plurality of images of objects in the installation could be displayed, from which the user could select one or more images for inclusion in his/her folder. Such a kiosk 42 could also be used to view the customer's folder in progress.

Returning to block 210, in some cases a device may be used that is in signal communication with the processor 16 operating at or for the central facility. An image is selected as above in blocks 211-217 (block 250). In addition, in such a case the software 17 can be used to transmit images over a network (block 251) so that the customer 11 can visualize the images as they could appear in a finished souvenir product (block 252), and thereby modify selections and captured images in “real time” if desired, which can include re-taking the image (block 253). Also, if desired, such a device can be used to present an audio and/or visual tour (block 254) through the site 12. This device could also be used in other ways known in the art, especially as such devices evolve, such as providing information on using the system 50, instructions on where to stand to have an image taken, how far along the customer is on the tour, etc. These examples are not intended to be limiting, and one of skill in the art will appreciate that such devices can be used in a myriad of ways interactively with the customer and the system.

Again returning to block 210, another process can be used to select images, if the customer device has read/write capabilities. This device can be used to store data instead of transmitting the data to the processor 16 during the customer's travels through the site 12.

In this embodiment, the customer 11 selects an image type as above in blocks 211-217 (block 260). An image identifier and the selected image type are then stored in a folder on the device (block 261).

The viewing and selection processes can be repeated until the customer's visit is complete (block 218), at which time s/he can proceed to the viewing/sales area 30 (block 219) if desired. Using the device, the customer's folder 18 is accessed, whether from the processor 16 or the device (block 220). Either the stored information or facial recognition software can be used to access all photographs having been taken that include or relate to the customer 11 (block 221). A benefit of having used multiple people in the customer image is that additional faces can aid in increasing the probability that the correct customer has been identified by a significant degree. For example, at present facial recognition may have a certain range of accuracy, whereas the addition of other data, such as other faces, clothing color, etc., can bring the probability close to 100%.

Each image and order in the folder 18 is processed according to type (block 222). An image containing a customer 11 is retrieved from the folder 18 (block 223), and a “stock” image without the customer 11 is retrieved from the database 31 (block 224). For those images wherein the customer 11 wishes to be inserted (block 225), the associated “stock” image is retrieved from the database 31, and the customer's image, as taken in step 208, is inserted thereinto digitally using techniques known in the art such as background replacement or compositing (block 226).

The customer 11 can also have the option to have the souvenir 13 enhanced with material stored in the database 31, such as age-appropriate informational textual material and/or additional images (block 227). For example, in a museum, didactic material relating to a particular objet d'art could be inserted.

Once the image collection is complete, the software 17 can be used to begin to create the customer's “album.” If the album is to be a physical object, there will typically be size limitations. The software 17 has a module for creating album pages automatically (block 228), making determinations as to page layout and relative size of images, for example. The software 17 can also select a layout and graphics based upon the customer's age. A complete “album” can then be digitally created (block 229), and the customer 11 can preview the album on a display 37, or on the customer device such as smart phone, and request revisions as desired, which can be entered via an input device 38 (block 230). The “album” can be in any form known in the art. If a DVD-type souvenir or a souvenir in some other format of digital recording is selected, stock video clips could form part of the souvenir 13.

If the souvenir 13 had not been purchased at the start of the visit (block 231), and if the customer 11 wishes to purchase the souvenir 13 (block 232), payment is arranged and received (block 233).

The final souvenir 13 is then delivered to the customer 11 in one or more forms known in the art (block 129).

In addition to, or instead of, a physical souvenir 13, an online option can be selected (block 235). If so, the customer data are cataloged (block 236). The images selected are correlated to determine the customer's interests (block 237). Then a person website 40 can be created for the customer 11 (block 238), which can be updated periodically with continuing age-and interest-specific educational and informational materials (block 239), and is accessible over the internet 41.

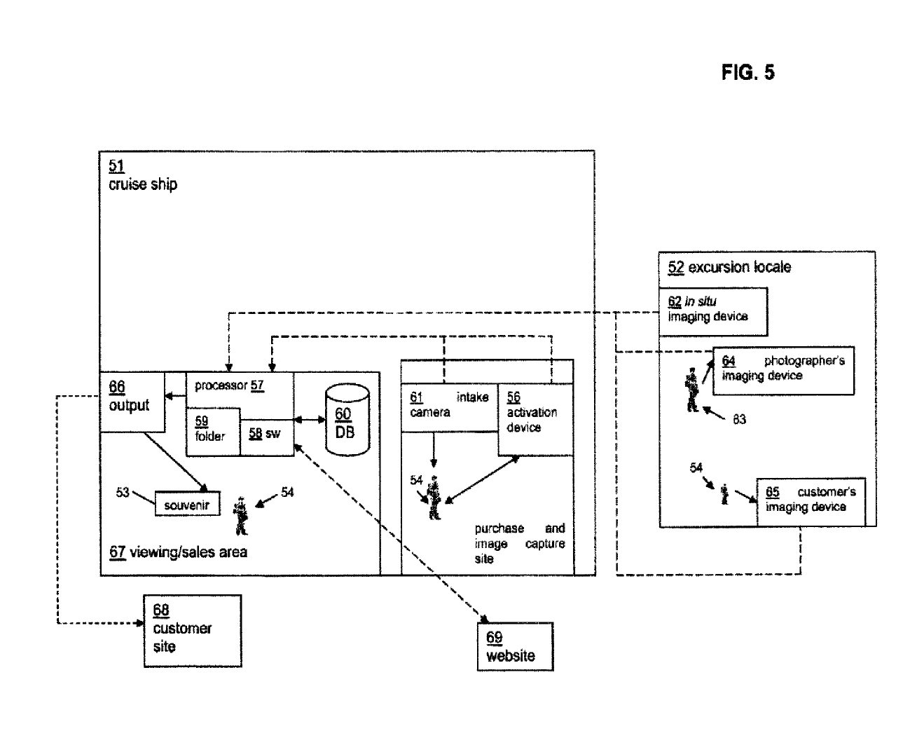

A system 70 (FIG. 5) and method 300 for use in a defined time period operates similarly to the system 10 and method 100 discussed above, with common reference numerals referring to analogous elements.

The system 70 and method 300 are preferably for use in a defined time period within one or more or sites, such as, but not intended to be limited to, a cruise ship 51 or other touring vehicle used as a base of operations and at least one side excursion site, such as a locale 52 visited as a day trip from a cruise ship 51, or any such sites known in the art. Herein the system and method will be discussed in terms of a cruise ship with side excursions, but this is not intended as a limitation, and is only used for ease of discussion.

The system 70 and method 300 provide a customer with a pictorial souvenir 53 of a vacation/tour. It will be understood by one of skill in the art that the words picture, image, camera, and photograph are not intended to be limited to a particular construction, and that still and moving images and recording devices can be contemplated thereby, and may include other media such as sound.

In a particular embodiment, a potential customer 54 enters a cruise ship 51 that has been outfitted with components for creating a pictorial memento 53 of the vacation (block 301). The opportunity to purchase this souvenir 53 can be offered to the customer 54 upon entering the ship 51, for example, at a pre-visit purchase and image capture site 55, an offer that can be accepted (block 302) or rejected (block 303) by the customer 54. In either case, the customer 54 can be given an encoded activation device 56 (block 304), which can comprise, for example, a key card with a readable magnetic stripe or other storage medium such as known in the art. This device can also comprise the customer's cell phone or a remote control device, or any other such device capable of transmitting a signal such as known in the art. The transaction related to establishing a customer ID and a link to the system's computerized central facility can be wholly electronic, such as by communications between a customer device such as a smart phone, tablet or personal computer and the system's central facility over the Internet or over a cell telephone system.

A protocol is established for communication between the activation device 56 and a processor 57, which has software 58 for creating a folder 59 specific to the customer 54 (block 305), which is storable on a database 60 in signal communication with the processor 57. In one embodiment, an initial image of the customer 54 can be captured by an intake camera 61 and stored in the folder 59 (block 306), for example, using “green screen” technology so that the customer's image can be embedded subsequently in other images if desired.

On the cruise ship, the customer 54 may desire to capture an image of and/or with an object (block 307) or other people, such as a dining group. There are several ways in which this may be accomplished, as discussed above, and these options will not be repeated here. Suffice it to say that images of the types previously described above with reference to blocks 109, 112, 114 (FIG. 2A) can be collected and stored in the customer's folder 59.

If the customer 54 travels off the cruise ship 51 to a shore excursion locale 52, analogous opportunities exist for images to be collected (block 308), whether via an automated process with an in situ imaging device 62 or a human photographer 63 operating an imaging device 64. Images can also be taken by an imaging device 65, preferably digital, operated and/or owned by the customer 54. The customer's imaging device 65 can comprise any device known in the art, such as but not intended to be limited to, a still camera, a video camera, and a cellular telephone having a camera associated therewith. If the customer's imaging device 65 has the capability, one or more of these collected images can be transmitted to the processor 57 for incorporation into his/her folder 59.

When the customer desires to complete a trip souvenir 53, which typically occurs at or near the end of the trip (block 309), s/he can proceed to a viewing/sales area 66 (block 310) if desired. Using the activation device 56, the customer's folder 59 is accessed (block 311). If the customer 54 wishes to augment the folder 59 with images from his/her own imaging device 65 (block 312), a transfer of such images can be made (block 313). The images are then processed as outlined above (block 314). One of skill in the art will appreciate that the customer 54 does not necessarily need to go to a physical location, and that these steps can be completed via computer or smart phone from any location on the ship, or even elsewhere, so long as connectivity is achieved.

Also as above, the customer 54 can have the option to have the souvenir 53 enhanced with material stored in the database 60, such as informational textual material and/or additional images (block 315). For example didactic material relating to a particular locale 52 that was visited, or historical information on the ship 51 could be inserted in the customer folder. A complete “album” can then be digitally created (block 316), and the customer 54 can preview the album on an output device 67 or a customer device such as smart phone and request revisions as desired (block 317).

If the souvenir 53 had not been purchased at the start of the visit (block 318), and if the customer 54 wishes to purchase the souvenir 53 (block 319), payment is arranged and received (block 320).

The final souvenir 53 is then delivered to the customer 54 in one or more forms as discussed above (block 321). For example, the souvenir 53 can take the form of a physical, printed album, which could be printed and bound on site. Alternatively, the souvenir 53 can take the form of a digital record, for example, stored on media. Further, the souvenir 53 can take the form of a digital record transmitted to the customer 54 at a desired site or device 68. Additionally, the souvenir 53 can be presented on a website 69 created for the customer 54 in connection with the trip. The digital media and record can contain both still and moving images and sound as desired.

The final souvenir 53 can comprise multiple forms and components as desired. Further, as above, some of the cost of producing the souvenir 53 can be defrayed by including advertising.

The many advantages offered by the systems 10, 50, 70 and methods 100, 200, 300 will be understood by one of skill in the art. The customer 11, 54 receives a professionally imaged and assembled souvenir 13, 53 containing images typically not possible or practical to be achieved by the customer 11, 54 him/herself, whether owing to perspective, vantage point, or quality, and retain all the pleasures of the visit without having to take photographs him/herself. Professional photographers are not required, since the cameras will have been set to take an optimal image, and all else is automated. “Stock” images will have been taken and stored under ideal conditions of lighting and vantage point, thereby minimizing the chance of causing damage to the objects by excess light.

Additionally, the interactivity of the systems 10, 50, 70 and methods 100, 200, 300 enable data to be collected on customers 11, 54 as to their preferences individually and collectively, which can be used to inform subsequent marketing and display strategies (block 240), including providing suggestions to the customer 11, 54 as to other attractions that might be of interest, based upon the customer's stored preferences.

In the case of some venues such as, without limitation, sports arenas, theme parks and museums, a customer's smart phone or tablet can be particularly useful as the activation device. For example, the phone can be provided with an application that establishes a communication link with a central computer that also communicates with automated cameras that are at selected locations in the venue and is configured through appropriate programming to operate the entire system. The customer can be offered such an application for downloading into the customers phone or tablet, of an already configured phone or tablet can be loaned to the customer. The customers phone or tablet can be provided with an icon that, when clicked or tapped, serves to indicate to the central computer to instruct an automated camera pointed to the current location of the customer, or to a location that the customer would like to have imaged for potential inclusion in the customer album, to take one or more images. The central computer can transmit the customer's album to the customer's phone or tablet at times selected by the customer or the system, so that the customer can view the album as it is being built and can edit the album by deleting images or other material or re-arranging images and other material, thus providing immediacy that is believed to encourage customers to have more images taken and to purchase an album. The customers locations can be tracked automatically, for example through the use of the GPS capability embedded in the phone or tablet. The album may be delivered to the customer's phone or table via WiFi or some other electronic link, so that the customer need not take time to stop and pick up a hard copy of the album. In addition, after any editing the customers album can become a book-like product that is printed at the venue or at another location. The customer's phone or tablet can further provide an audio input that is transmitted to the central computer to be merged with images in the customers folder, for example to provide audio captions to the images.

As another example, the activation device can trigger the automated image taking by being present at a specified location. For example, ski resorts, Marathon or parade routes, or other venues can be provided with sensors to detect the proximity of a device carried by the customer, such as an RF tag. The tags are associated with respective customers, so that an image of the customer is automatically taken when the customer is at the sensed locations and is added to the customer's album.

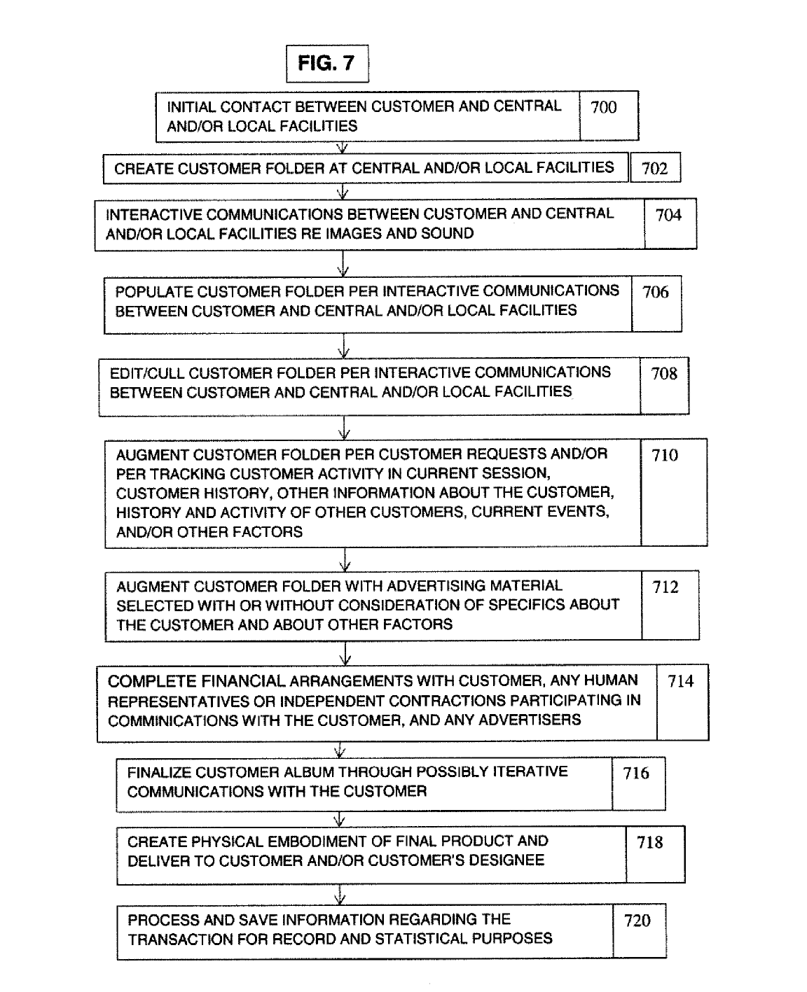

FIG. 7 illustrates steps that can be included in examples of the systems and method described in this patent specification. Depending on the particular implementation details, the steps need not be performed in the indicated order, and not all steps may be needed. In step 700 a customer establishes initial contact with the central systems, which contact may be direct, or it may involve contact with a human representative or an independent contractor serving as an intermediary between the customer and the central facility for some of the operations to follow. If the contact is directly with the central facility, it can be in any one or more of the ways referred to above. For example, the customer can contact the central facility from a device such as a smart phone or from another electronic device that the customer owns or the system provides to the customer or to which the system affords access by the customer for the purpose of a session that would create a customized album for that customer. In the example of a dedicated imaging facility, a museum, a library, and the like, the contact can be through touch screens or other interface devices that are built in and the customer can operate. If the contact involves a human representative, the representative can identify the customer for the session to follow in any one or more ways such as giving the customer a uniquely identified item such as a card with unique indicia, taking an initial picture of the customer and/or the card, key-in identifying information about the customer in an electronic device that the representative carries, etc. The representative can transmit the customer identification to the central facility immediately or later, at any time throughout the session in which the customer is involved. The result of step 700 typically is a link between the customer and one or more folders, or potential folders, for images of or relating to the customer and other information about the customer. This link can be directly with the central facility or can be initially only with equipment that the human representative carries or controls. In some embodiments this initial contact can take place after some or all images of or relating to the customer have been taken, as in the examples of imaging a venue or an event such as a sports facility or a sports event and later offering potential customers an opportunity to select images or portions of images for a customized album. The customer identity can include additional information about the customer such as the customer location, e.g., the customers seat in a sports arena, or the customer initial and/or updated location, for example by using an electronic device that affords location tracking or using face recognition.

Step 702 creates one or more customer folders at the central facility and/or the local facility. The central facility can be one or more computer facilities that need not be all in the same place so long as the requisite communication paths with the customer and any human representative and advertisers can be established and maintained as needed for the remainder of the session involving the customer. The customer folder can reside in one or more locations in computer memory that can be identified as linked with that customer. If a human representative is involved, the customer folders can reside for some time only at equipment carried or controlled by the representative. For a venue such as at a museum or a theme park, the entire central facility can be at that location, or some can be at a remote location, and there can be an additional central facility that duplicates and/or supervises/controls at least some of the computer operations of the local venue. In some embodiments, the creation of customer folders can take place at a later stage, for example when participants in a sports event such a foot race can view race images and decide to become customers who can select already taken images for inclusion in customized albums.

Step 704 involves interactive communications between customers and the system. Where the communications do not involve human intermediaries, they can be through devices such as a customers smart phone, an electronic device lent to the customer for the session, a built-in device such as keyboards or touch panel or buttons at the venue, the customer's presence at specified locations in the venue, hand gestures by the customer, etc. These communications can involve requests or assents by the customer about where and when to have images taken and/or sound recorded and what the images and sound should cover, and any information that the system may convey to the customer such as where to have images taken or sound recorded, etc. In embodiments where human representatives are involved, some or all of these communications can be by speech or gestures.

Step 706 involves the population of the customer folder or folders with images and any sounds. In the example of a venue such as a museum, a customer can stand near a painting or stature and request an image by operating a cell phone or other device to request an image and then to start a count-down for taking an image, and the system responds by operating an automated camera and possibly automated lighting as needed to take one or more images of the customer or the customer group and by storing the images and any related sound in the customer folder. The system may send proofs of the taken images to the customer device or to some other device to which the customer has access, and the customer can send back to the system information such as a request to re-take images or to delete images or to keep images. In an example such as a sports arena in which a game is on, the communications can involve actively sent or passively acquired information about the customer moving from one location to another, such as a smart phone message by the customer that he or she has changes seats, or location tracking of the customer through GPS or some other similar system or face recognition tracking of the customer. When a human representative is involved, the communications can be by personal contact in addition to or instead of the types of electronic contact discussed above. For any given customer and session with the system, these communications can be continuous, or intermittent, and in some cases can be fully automated so no purposeful action by the customer would be required. The result of step 706 is a customer folder that is populated with images and possibly sounds that can be further processed for create a customized album for that customer.

Step 708 involves further processing of the contents of the customer folder. The system can send to the customer proofs of some or all of the images in the customer folder, so that the customer can request editing such as cropping or other changes, or can request deletion of some images. Some or all of such editing/culling can be done by the customer, for example on a customer devices such as a smart phone or on equipment at the site to which the customer has access, such as a touch screen that displays images to the customer and instructs the customer how to edit or delete images. If a human representative is involved, equipment carried by or available to the human representative can be used for that purpose, with the human representative assisting the customer as needed for editing or culling of images. Similar interactive processing can be done at any time during the session, from the first time images of or for the customer are taken or sound recorded, to the time just before the customer album is delivered to or for the customer, but typically would take place after the customer folder is fully populated with images and sound for the album.

In step 710, the system can augment the customer folder with additional images, sounds, and other material. This can be done partly or entirely at the customer request and direction, or partly or entirely based on determination the central and/or local system facilities and/or any human representative or advertiser makes, or can be based on a combination of decisions by some or all the persons and entities that are involved. The augmenting material can be separate from the images taken of or for the customer, or it can be blended with such images, for example by compositing images taken of or for the customer with other images, and similar blending can be done for sound. In the example of an album that memorializes a customer's museum visit, the customer images can be augmented by adding stock images of art that the customer has seen and perhaps has viewed for longer time intervals, text about the artist or the historical context, music that might be relevant to the artist or period, suggestions for future visits, advertising material, etc. In the example of a visit to a ball game, the customer folder can be augmented with material such images of the ball park, of significant moments in the game, with information regarding teams, players, statistics, etc. In the example of park or zoo visits, the customer folder can be augmented with images of park or zoo features, or animals, etc. Some or all of this material can be selected for addition to the folder by the customer. For example, using a smart phone or other communication device the customer can request an image of some feature or activity at the venue that may or may not include the customer, and the system can respond by operating automated equipment to take the images or record the sound, or can retrieve stock images for addition to the customer's folder. Alternatively or in addition, the programmed computer equipment of the central and/or local facilities can select material for addition to the customer folder, using for the purpose algorithms that take into account information from or about the customer, e.g., that the customer lingered long when viewing a painting, or take into account a profile of the customer that the system has created. For example, the profile may suggest that the customer is likely to favor a sports team or player, or that customers in the venue have been highly interested in an image of a particular feature, e.g., an air view of a ball park, or that a particular play that just took place is memorable and an image related to it is likely to be of interest, and/or any or a number or other factors that may make it likely that the customer will be interested in such material. As mentioned, some or all of the material can be composited with images or sound of or for the customer. For example, the central/local facility computer equipment can composite an image of the customer into an image of a ball team.

In step 712, the system can augment the customer folder with advertising material, for which the system can receive compensation from advertisers. The advertising material inserted in the customer folder can be selected for the particular customer, for example in the way Google or Amazon select advertising material based on customer behavior, or it can be selected without regard for the customer's likely interests and preferences. For example, advertising material for a business or an event can be added to the folder for each customer at a venue at a given time frame.

In step 714 financial arrangement are completed with the customer and any human representatives, independent contractors, or advertisers based on factors such as the current state of the customer folder, or after it has been edited, culled and augmented as discussed above. The operations involved in this step can be distributed in time in that some can take place before and/or during the taking of images and recording of sound, some or all may make place during or after the editing and culling of the customer folder, and some or all may take place at a time related to the finalization of the customer album and/or the delivery of the album to or for the customer. The specific details of this step depend on the details of the implementation that a particular system operation has selected, and can use algorithms similar to those employed by providers of goods or services over the Internet, e.g., Amazon or Apple.

Step 716 involves finalizing the customer album. It can include interactive communication with the customer, for example, showing a preview version to the customer on a customer device or a device made available to the customer so that the customer can respond with requests for changes such as re-arranging or dropping images or sound, or this step can be carried out by the system without direct input from the customer, using known or customized technology for assembling images and other material into an album, similar to those used to assemble material for a magazine or newspaper and create layouts.

Step 718 pertains to creating a physical embodiment of the customer album and its delivery to or for the customer. The physical embodiment can be a printed album, using printing facilities at the venue, such as higher quality color printers and binders, so that the album can be handed over to the customer immediately. Instead or in addition, the album can be printed at a remote facility that the customer or the system operates or designates, for example a print shop convenient to the customer or a print facility that can mail or otherwise deliver an album to a person or address that the customer designates. And, instead or in addition, the physical embodiment can be an electronic version of the album that the system can deliver electronically to the customer's device or facility such as a smart phone, a tablet, a personal computer, a web site, etc., and/or the album can be embodied in a physical medium such as an optical disc, a flash drive, or a similar product that can be handed to or otherwise delivered to the customer or the customer's designee.

Step 720 can take place at any time, for example during or after the performance of the other steps, and involves processing and saving information regarding the transaction with the customer, including the image taking and editing/culling session, any sound recording, and any other information regarding the customer that has become available to the system. This information can be used to create and save a customer profile or format to be used in a future encounter with the customer or to direct informational and advertising material to the customer, and for statistical purposes to create a database that can be used to enhance the systems and methods discussed above.

In the foregoing description, certain terms have been used for brevity, clarity, and understanding, but no unnecessary limitations are to be implied therefrom beyond the requirements of the prior art, because such words are used for description purposes herein and are intended to be broadly construed. The terms central facility and central computerized facility have been used in a broad sense, to encompass a distributed facility that may include or be implemented in a dedicated computer, plural computers, and equipment carried by a human representative or located at a specific venue. Facilities and steps from one of the examples of embodiments can be used in combination with those of other examples of embodiments.

At least some of the process steps described above can be formatted as algorithmic steps represented by a computer program that, when loaded into a suitable computer system, causes the system to carry out those steps. In such as case, computer-readable media in which such a program is stored in non-transitory form, can be considered to be a computer program product.

The embodiments of the systems illustrated and described herein are by way of example, and the scope of the invention is not limited to the exact details of construction and use. Components and features described in one embodiment can be used instead of or in addition to components and features described in the context of other embodiments.

1-29. (canceled)

30. An automated system configured to create customized pictorial souvenirs of customers' visits at a venue, comprising:
multiple, high-definition, video cameras having fields of view covering respective fixed areas in the venue and each operating in a video mode over selected multi-frame time intervals to output respective sequences of frames of camera output images;
wherein each of the frames comprises an image of a respective multiplicity of locations for customers so that in the presence of customers each of the frames comprises an image of a respective multiplicity of customers;
a computer system having image storage facilities and associated with the cameras and configured to receive and store the sequences of frames of camera output images;
a communication facility configured to receive, from customer devices, customer requests for images of individual customers or groups of customers who are fewer in number that the multiplicity of customers imaged in the respective frames containing the requested images and to convey the requests to the computer system;
the computer system being further configured to respond to the requests conveyed thereto by the communication facility by selecting the frames from the storage facilities that include pixel groups associated with the requested images, and to identify said pixel groups in the respective frames;
the computer system being further configured to generate the requested images of customers or groups by applying image processing to the identified pixel groups, including electronic zooming;
the computer system being further configured to produce preview images that are degraded versions of the requested images, and said communication system being further configured to send the preview images to the customer devices associated with the respective requests and to receive image purchase information from those customer devices and convey the image purchase information to the computer system; and
the computer system being further configured to respond to the image purchase information to produce and send to customer devices final images that are high quality versions of the requested images identified by the purchase information, formatted as pictorial souvenirs of customers' visits.

31. The automated system of claim 30 wherein the computer system is configured to receive audio from selected customer devices and to associate the audio with respective images of the customers or groups associated with those customer devices and include the audio and associated images of the customers or groups in the respective pictorial souvenirs.

32. The automated system of claim 30 wherein the customer requests for images comprise requests for multi-frame video clips of images that are only subsets of the content of respective frames output from respective cameras, and wherein the computer system is configured to send the requested video clips to the respective customer devices.

33. The automated system of claim 32 wherein the customer requests for video clips specify time spans over which the respective video clips are taken, and the computer system is configured to identify the camera output images for those time spans.

34. The automated system of claim 32 wherein the computer system is configured to send preview images comprising the requested video clips, and to receive from selected customer devices versions of the video clips that have been edited on the respective customer devices, and to include the edited clips in the respective pictorial souvenirs.

35. The automated system of claim 30 wherein the computer system is configured to receive from respected customer devices requests for images of customers generated at least in part by tapping symbols on touch screens of those customer devices.

36. The automated computer system of claim 30 wherein the computer system is configured to automatically transmit at least portions of the pictorial souvenirs to social media sites in response to commands received from selected customer devices.

37. The automated system of claim 30 wherein the computer system is configured to selectively carry out calibration of the camera system that includes verifying or correcting the field of view of respective cameras.

38. The automated system of claim 37 including utilizing selected fiducials in the field of view of selected cameras in the calibration process.

39. The automated system of claim 30 wherein one or more of the customer requests specify a time in the future for taking the requested customer images to thereby allow the customers for pose for the images.

40. The automated system of claim 30 wherein one or more of the customer requests specify a time in the past relative to the time of the request, and the computer system is configured to search the image storage facility for camera images previously taken to extract image frames taken at the specified time.

41. The automated system of claim 30 wherein the computer system is configured to identify locations of customers by using face recognition technology applied to respective camera images.

42. The automated system of claim 30 wherein the computer system is configured to create customer folders for respective customers that include selected information for respective customer, and to use the selected information at subsequent visits of the customers at the venue to simplify or reduce the content of the respective of customer purchase information.

43. The automated system of claim 30 wherein the venue includes fiducials in fields of view of at least some of the cameras, and said computer facility is configured to use pixel groups in the images that are associated with fiducials in identifying pixel groups associated with customer requests.

44. The automated system of claim 30 wherein at least some of the cameras arc wide view cameras with fields of view covering respective overlapping fixed areas of the venue.

45. The automated system of claim 30 wherein the computer system is configured to form composite images of customers with other images in forming the preview and final images.

46. The automated system of claim 30 wherein the computer system is configured to respond to customer request for images that include people in addition to the customer or a customer group requesting the images by providing final images with degraded content of faces of such additional people to thereby provide a measure of privacy for the additional people.

47. The automated system of claim 30 wherein the computer system is configured to respond to image editing requests received from customer devices via the communication facility to edit the final images according to the editing requests.

48. The automated system of claim 30 wherein the computer system is configured to include in the final images material in which third parties hold rights, and to calculate and provide payments for such material to third parties.

49. The automated system of claim 30 in which the computer system is configured to include promotional material in at least one of the preview and final images and to calculate and obtain payment from third parties for such inclusion of promotional material.

50. A method of creating customized pictorial souvenirs of customers' visits at a venue, comprising:
imaging respective areas in the venue from respective angles with respective high-definition cameras that operate in video mode over selected time intervals to provide respective camera multi-frame camera output images;
wherein over said selected time intervals each camera images only a respective fixed and unchanging area of the venue;
storing the camera output images in a computer-controlled storage facility;
computer-processing customer requests sent wirelessly by customer devices to thereby identify locations of customers, automatically selecting images from the storage facility that include pixel groups associated with respective customer requests, and automatically identifying through said computer-processing the pixel groups and generating therefrom requested images by cropping and/or zooming image processing;
generating preview images by computer-processing the generated requested images to degrade them, sending the preview images to respective customer devices, and receiving image purchase information from customer devices;
responding to image purchase information to generate, from respective requested images and through computer-processing and send to customer devices, high quality final images that are formatted as pictorial souvenirs of customers' visits.

51. The method of claim 50 wherein the camera output images include images of fiducials in the venue that are in fields of view of at least some of the cameras, and wherein the computer-processing uses pixel groups in the images that are associated with such fiducials in identifying pixel groups associated with customer requests.

52. The method of claim 50 including inserting sound in at least some of the preview and final customer images.

53. The method of claim 52 in which the sound is generated at wirelessly transmitted from the customer devices.

54. The method of claim 50 wherein the customer requests comprise requests for video clips, and wherein one or more of the final images comprise video clips wirelessly transmitted to customer devices, wherein the video clips comprise only subsets of the respective images in the respective frames output from the cameras.

55. The method of claim 54 wherein the customer requests for video clips specify time spans over which the respective video clips are taken, and including automatically identifying the camera output images for those time spans.

56. The method of claim 50 wherein at least a part of some of the customer request, comprise information generated by tapping symbols on touch screens of customer devices.

57. The method of claim 50 including automatically transmitting at least portions of the pictorial souvenirs to social media sites in response to commands received from selected customer devices.

58. A computer program product stored in a non-transitory form in computer-readable media and comprising instructions that when loaded into and executed by a computer system cause the computer system to carry out the steps of:
receiving images from multiple high-definition cameras that image respective areas in a venue from respective angles and operate in video mode over selected time intervals to provide respective multi-frame camera output images;
wherein during said selected time intervals the respective cameras image only fixed and unchanged areas of the venue, without optical tilt/pan/zoom;
storing the camera output images in a computer-controlled storage facility;
computer-processing customer requests to thereby identify locations of customers in the venue, selecting images from the storage facilities that include pixel groups associated with respective customer requests, and identifying through said computer-processing the pixel groups and generating therefrom requested images of customers by electronic image processing involving electronic rather than optical cropping and/or zooming;
generating preview images by computer-processing the requested images to produce degraded preview, sending the preview images to respective customer devices, and receiving image purchase information from customer devices; and
responding to image purchase information to generate high-quality final versions of respective requested images through computer-processing, and to wirelessly send the final images to customer devices.
